(19) United States
(12) Patent Application Publication
(10) Pub. No.: US 2024/0329932 A1
(43) Pub. Date: Oct. 3, 2024

(54) MULTIPLICATION CIRCUITRY, APPARATUS, SYSTEM, CHIP-CONTAINING PRODUCT, METHOD AND COMPUTER-READABLE MEDIUM

(71) Applicant: Arm Limited, Cambridge (GB)

(72) Inventor: Nicholas Andrew PFISTER, Austin, TX (US)

(21) Appl. No.: 18/129,973

(22) Filed: Apr. 3, 2023

(51) Int. Cl. G06F 7/527; G06F 7/501; G06F 7/533

(52) U.S. Cl. CPC G06F 7/5272; G06F 7/501; G06F 7/533

(57) ABSTRACT

Multiplication circuitry comprises at least two adder arrays each to add a respective set—of partial products to generate a respective product representing value representing a result of multiplication of a respective pair of portions of bits selected from first and second operands. The adder arrays comprise separate instances of hardware circuitry having at least two separate enable control signals for independently controlling whether at least two subsets of adder arrays are enabled or disabled. Booth encoding circuitry is shared between the adder arrays, to Booth encode the first operand to generate partial product selection indicators each corresponding to a Booth encoding of a respective Booth digit of the first operand. At least two adder arrays operate on respective partial products selected by partial product selection circuitry based on a same partial product selection indicator generated by the shared Booth encoding circuitry based on a same Booth digit of the first operand.

### BACKGROUND

### Technical Field

The present technique relates to the field of data processing.

### Technical Background

A processor may have logic circuitry for implementing various arithmetic or logical operations. One arithmetic operation to be supported by a processor may be a multiplication operation. While the arithmetic operation for the multiplication operation is well-defined, there is design choice to be made in how to implement hardware circuit logic for performing that operation within a processor. Design decisions made by the circuit designer may have an impact on processing performance and/or energy efficiency.

### SUMMARY

At least some examples of the present technique provide multiplication circuitry comprising:

a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;

shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and

partial product selection circuitry to select, based on the second operand and the plurality of partial product selection indicators, the partial products to be added by the plurality of adder arrays; in which:

at least two of the adder arrays are configured to operate on respective partial products selected by the partial product selection circuitry based on a same partial product selection indicator generated by the shared Booth encoding circuitry based on the Booth encoding of a same Booth digit of the first operand.

At least some examples of the present technique provide an apparatus comprising: processing circuitry to perform data processing in response to instructions, the processing circuitry comprising the multiplication circuitry described above.

At least some examples of the present technique provide a method comprising:

using shared Booth encoding circuitry shared between a plurality of adder arrays, Booth encoding a first operand to generate a plurality of sets of partial product selection indicators, each partial product selection indicator corresponding to a Booth encoding of a respective Booth digit of the first operand, wherein the plurality of adder arrays comprise separate instances of hardware circuitry, the plurality of adder arrays having at least two separate enable control signals for independently controlling whether at least two subsets of the adder arrays are enabled or disabled;

selecting, based on a second operand and the plurality of partial product selection indicators, respective sets of partial products to be added by a plurality of adder arrays; and

adding the partial products using enabled adder arrays of the plurality of adder arrays to generate respective product representing values each representing a result of multiplication of a respective pair of portions of bits selected from the first operand and the second operand,

wherein at least two of the adder arrays are configured to operate on respective partial products selected based on a same partial product selection indicator generated by the shared Booth encoding circuitry based on the Booth encoding of a same Booth digit of the first operand.

At least some examples of the present technique provide a non-transitory computer-readable medium to store computer-readable code for fabrication of multiplication circuitry comprising:

a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;

shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and

partial product selection circuitry to select, based on the second operand and the plurality of partial product selection indicators, the partial products to be added by the plurality of adder arrays; in which:

at least two of the adder arrays are configured to operate on respective partial products selected by the partial product selection circuitry based on a same partial product selection indicator generated by the shared Booth encoding circuitry based on the Booth encoding of a same Booth digit of the first operand.

At least some examples provide a system comprising: the multiplication circuitry described above, implemented in at least one packaged chip; at least one system component; and a board, wherein the at least one packaged chip and the at least one system component are assembled on the board.

At least some examples provide a chip-containing product comprising the system described above assembled on a further board with at least one other product component.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing apparatus;

FIG. 2 illustrates an example of multiplication circuitry;

FIG. 3 illustrates, for comparison, an approach in which each adder array has its own private instance of Booth encoding circuitry;

FIG. 4 illustrates an example where shared Booth encoding circuitry is shared between the adder arrays;

FIG. 5 illustrates the adder arrays in more detail;

FIGS. 6A to 6D illustrates mapping of the adder arrays onto portions of a multiplication operation performed in different data element size configurations;

FIG. 7 illustrates bit selection for the Booth digits of the first operand which are Booth encoded by each Booth encoder of the shared Booth encoding circuitry;

FIG. 8 illustrates, for each adder array, which portion of the second operand (and which Booth encoder) is used to select each partial products to be added by the adder array;

FIG. 9 illustrates the addition of partial products for 8-bit adder arrays;

FIGS. 10A and 10B illustrate the addition of partial products for 16-bit adder arrays;

FIGS. 11A and 11B illustrate the addition of partial products for 32-bit adder arrays;

FIG. 12 illustrates the addition of partial products for an adder array used to provide extra bits used in a 64-bit multiplication that are not required for 8-bit, 16-bit or 32-bit multiplication operations;

FIG. 13 shows relative alignment for additions of product representing values in a cooperative mode;

FIG. 14 is a flow diagram illustrating a method of performing a multiplication using multiplication circuitry; and

FIG. 15 illustrates an example of a system and chip-containing product.

### DESCRIPTION OF EXAMPLES

Multiplication circuitry comprises two or more adder arrays each to add a respective set of partial products to generate a respective product representing value representing a result of multiplication of a respective pair of portions of bits selected from a first operand and a second operand. Each adder array comprises a separate instance of hardware circuitry. The adder arrays have at least two separate enable control signals for independently controlling whether at least two subsets of adder arrays are enabled or disabled. Providing respective subsets of adder array each with independent enable/disable control, with each adder array being capable of providing a respective product representing value representing the result of multiplication of a respective pair of portions of bits from the first and second operands, can be useful to support multiplication operations on portions of the first operand and second operand corresponding to different data types, for example.

The partial products added by each adder array are selected based on the second operand and based on partial product selection indicators generated by Booth encoding circuitry. Booth encoding is a technique used in multiplication circuits to reduce the number of partial products which need to be added to produce a multiplication result. Booth encoding is based on treating the first operand as a series of overlapping Booth digits (each Booth digit comprising a certain number of bits of the first operand) and analyzing the bit pattern of each Booth digit to identify positions at which runs of successive 1s start/end in the first operand. For a given Booth digit of the first operand, a corresponding partial product selection indicator is generated which represents the Booth encoding of the Booth digit. The partial product selection indicator controls partial product selection circuitry to select a corresponding partial product to be added by one of the adder arrays. For example, a given partial product may be a selected multiple of a portion of the second operand, with the corresponding partial product selection indicator used to select between different multiples of that portion of the second operand.

Where a number of independently enabled/disabled subsets of adder arrays are provided for generating respective product representing values, a typical approach would be to provide each adder array with its own private instance of Booth encoding circuitry, not shared with the Booth encoding circuitry used by other arrays.

However, the inventor recognised that there is an opportunity to save circuit area and power consumption based on a recognition that the different adder arrays may be Booth encoding the same operand or the same subsections of that operand, so that it is possible to share the Booth encoding circuitry between the adder arrays. Hence, shared Booth encoding circuitry is provided, that is shared between the plurality of adder arrays, to Booth encode the first operand to generate the partial product selection indicators, each partial product selection indicator corresponding to a Booth encoding of a respective Booth digit of the first operand. At least two of the adder arrays are configured to operate on respective partial products selected by the partial product selection circuitry based on a same partial product selection indicator generated by the shared Booth encoding circuitry based on the Booth encoding of a same Booth digit of the first operand. By providing shared Booth encoding circuitry, overall circuit area and power consumption of the multiplication circuitry can be reduced. This technique can also help to reduce pressure on meeting circuit timings, due to not needing to retain as many bits for the partial product selection indicators compared to an implementation with private non-shared Booth encoders for each adder array.

Each adder array generates a respective product representing value, which indicates the numerical result of a respective pair of portions of bits selected from a first operand and a second operand. Hence, one adder array may generate the product representing value representing the product of a first portion of the first operand and a corresponding first portion of the second operand. Another adder array may generate the product representing value representing the product of a second portion of the first operand (which could be overlapping or non-overlapping with the first portion) and a corresponding second portion of the second operand. Each product representing value may represent the numerical result of an A-bit*B-bit multiplication of the corresponding portions of bits taken from the first and second operands respectively (where A can be equal to B or A can be greater than or less than B, and the values of A and B can be the same for two or more adder arrays or could differ between one adder array and another). Each product representing value represents the numerical result of the A-bit*B-bit multiplication (so is not merely an intermediate step representing a partial sum of only some of the partial products corresponding to the A-bit*B-bit multiplication). However, the numerical result can be represented in different forms. For example, the product representing value could represent the numerical result in a carry-save format using a sum term and a carry term. For example, the adder array could comprise a carry-save-adder tree which does not propagate carries from one bit lane to another, but performs a series of 3:2 carry-save add reductions to reduce the set of partial products to a sum term and a carry term which when added together by a further carry propagate adder (not part of the adder arrays) may produce a number representing the numeric result of the A-bit*B-bit multiplication in binary representation. Hence, it will be appreciated that the output of each adder array could represent the product representing value in a carry save form.

The multiplication circuitry is configured to support at least two data element size configurations for multiplication of one or more respective pairs of data elements selected from the first operand and the second operand, each data element size configuration corresponding to a different combination of data element sizes for the data elements selected from the first operand and the second operand. For example, the data element size configurations can correspond to different SIMD element sizes for a SIMD (single instruction, multiple data) multiplication operation. For example, the first and second operands could be vector operands and each data element could be a respective vector element. In another example, the first and second operands could be matrix operands and each data element could be a respective matrix element.

For example, each individual adder array may be sized appropriate for a specific data element size configuration, and selection of which adder arrays are enabled/disabled may depend on the current element size configuration in use. Hence, enable control circuitry may select, based on the current data element size configuration to be used for the multiplication operation, which of the adder arrays are to be enabled and which of the adder arrays are to be disabled. Use of at least two subsets of adder arrays with independent enable/disable control can provide greater energy efficiency for implementing multiplications with different data element size configurations, compared to an implementation which provides a single large adder array and relies on injecting 0s for some of the partial product bits when performing multiplications with a data element size smaller than the maximum supported size.

For the Booth encoding of a given Booth digit of the first operand: for at least one of the data element size configurations for which the given Booth digit spans a data element boundary, the shared Booth encoding circuitry may generate the Booth encoding of the given Booth digit based on a least significant bit of the given Booth digit being set to 0; and for at least one other of the data element size configurations for which the given Booth digit does not span a data element boundary, the shared Booth encoding circuitry may generate the Booth encoding of the given Booth digit based on the least significant bit of the given Booth digit being set to a value of a corresponding bit of the first operand. Hence, by providing, in the shared Booth encoding circuitry, selection circuitry to select whether the least significant bit of the given Booth digit is treated as 0 or the corresponding bit of the first operand, this allows the same Booth encoding circuitry to be shared between the different adder arrays, even when those adder arrays are based on data element size configurations which mean that the given Booth digit of the first operand will span the element boundary for one configuration but not for another.

The adder arrays may comprise at least:
a first subset of adder arrays for which each respective product representing value represents the result of multiplication of a respective pair of data elements selected from the first operand and the second operand according to a first data element size configuration; and
a second subset of adder arrays for which each respective product representing value represents the result of multiplication of a respective pair of data elements selected from the first operand and the second operand according to a second data element size configuration.

For the sharing of the Booth encoder between adder arrays, the at least two adder arrays described above (those adder arrays for which the respective partial products are selected based on the same partial product selection indicator) may comprise an adder array of the first subset and an adder array of the second subset. This may reflect that in the first/second data element size configurations, the first/second subsets of adder arrays operate on the same subsections of the first operand (although those subsections may be logically divided into different data element configurations), so regardless of which data element configuration is active, the same hardware circuit logic can be used to analyze the bit pattern of a given Booth digit of the first operand and provide a corresponding partial product selection indicator used by the partial product selection circuitry to select respective partial products for both the adder array of the first subset and the adder array of the second subset.

Although the same partial product selection indicator is used for both an adder array of the first subset and an adder array of the second subset, the partial product selected for the adder array of the first subset based on that same partial product selection indicator may be dependent on a first subset of bits of the second operand when the multiplication is to be performed according to the first data element size configuration, and the partial product selected for the adder array of the second subset based on that same partial product selection indicator may be dependent on a second subset of bits of the second operand when the multiplication is to be performed according to the second data element size configuration. Hence, although the same partial product selection indicator is used for respective adder arrays in both the first subset and the second subset, the value of the corresponding partial products used by those respective adder arrays in the first/second subsets can still be different because those partial products may be based on different portions of the second operand.

Enable control circuitry may be configured to set one or more enable control signals for the first subset of adder arrays to disable the first subset of adder arrays, in response to current data element size configuration information specifying that the first data element size configuration is not needed for a given multiplication operation performed on the first operand and the second operand; and set one or more enable control signals for the second subset of adder arrays to disable the second subset of adder arrays, in response to the current data element size configuration information specifying that the second data element size configuration is not needed for the given multiplication operation. Hence, the first subset of adder arrays may be enabled when the first data element size configuration is required, and the second subset of adder arrays may be enabled when the second data element size configuration is required. If one of the first/second data element size configuration is not required, the corresponding one of the first/second subsets of adder arrays can be disabled to save power.

The enable control circuitry may support performing, in parallel, multiplication operations on the first and second operands using both the first data element size configuration and the second data element size configuration, by enabling both the first subset of adder arrays and the second subset of adder arrays using the enable control signals. Although often only one of the data element size configurations may be required at a given time, there can be some use cases where it is useful to process the same first and second operands with more than one different data element size configuration to generate corresponding sets of product results for two or more data element size configurations. For example, this can be useful in some machine learning or graphics processing applications. For example, two vector operands J and K could be processed to generate both a first vector result L providing a set of product representing values each corresponding to the result of multiplying corresponding pairs of 32-bit elements of J and K, and a second vector result M providing a set of product representing values each corresponding to the result of multiplying corresponding pairs of 16-bit elements of J and K. By implementing the multiplication circuitry using a number of subsets of adder arrays each corresponding to a given data element size configuration and each with independent enable/disable control, this can support such parallel multiplication operands performed on the same operands according to more than one data element size configuration.

While the examples discussed refer to a first subset of adder arrays and a second subset of adder arrays, it will be appreciated that the same techniques could be extended to three or more subsets of adder arrays. For example, the plurality of adder arrays may also comprise a third subset of adder arrays for which each respective product representing value represents the result of multiplication of a respective pair of data elements selected from the first operand and the second operand according to a third data element size configuration. For example, the first, second and third subsets of adder arrays could be used for 8-bit, 16-bit, 32-bit multiplications respectively.

The adder arrays can also be used in a cooperative mode where they cooperate to perform respective portions of a larger multiplication. Product adding circuitry may add, for a multiplication operation in which two or more of the adder arrays are to operate in a cooperative mode, the respective product representing values generated by two or more of the adder arrays to generate a product result value representing the multiplication of wider portions of bits of the first operand and the second operand than the portions of bits used to generate the respective product representing values for any one of said two or more of the adder arrays. For example, where respective adder arrays are provided to support at least two of 8-bit, 16-bit and 32-bit data element configurations respectively, those adder arrays may also be mapped to respective portions of the partial product additions required for a larger multiplication operation (e.g. with 64-bit elements). Implementing a larger multiplication operation using a number of independently enabled/disabled smaller adder arrays in this way can provide a more power-efficient way of implementing options for both a smaller-size and larger-size multiplication operation, compared to alternative approaches such as the injection of zeroes into a single monolithic large multiplier as discussed above.

For at least one adder array, the portion of the second operand used to form the partial products for that adder array is variable depending on whether the multiplication operation is to be performed in the cooperative mode. For example, the partial product selection circuitry may select the portion of the second operand used to form the partial products for that adder array as a first portion of the second operand when the multiplication operation is to be performed in a non-cooperative mode (with each adder array operating individually to produce an independent product representing value) and a second portion of the second operand when the multiplication is to be performed in a cooperative mode (with the adder arrays generating respective product representing values which can further be added together by the product adding circuitry to generate the product result value representing the result of the wider multiplication).

In some examples, the wider portions of bits of the first operand and the second operand comprise all magnitude-indicating bits of the first operand and the second operand. For example, where the first/second operands are vector operands based on signed/unsigned integer data types, the cooperative mode may provide full-operand-width multiplication of a number represented by all bits of the first operand and a number represented by all bits of the second operand. Also, for an example where the first/second operands are floating-point operands comprising bits representing a sign (positive or negative), an exponent and a fraction, the magnitude-indicating bits may be the bits of a significand represented by the fraction (so the bits of the first/second operands corresponding to the sign and exponent may not be considered magnitude-indicating bits of the first/second operands).

In other examples, the wider portions of bits of the first operand and the second operand need not comprise all magnitude-indicating bits of the first operand and the second operand.

For example, the cooperative mode can be used to cause adder arrays to work together to compute a multiplication result for a data type which does not correspond to the maximum supported size representable using the first/second operand, but which does not have adder arrays supporting that data type natively. In this case, it may be that only some of the adder arrays need to cooperate to provide the multiplication result for that data type, so some of the adder arrays may not be needed (and so can be disabled using the corresponding enable control signal) even in the cooperative mode, depending on the configuration option selected for a particular multiplication operation.

In one example, the adder arrays comprise:
a plurality of subsets of adder arrays corresponding to different data element size configurations, each subset of adder arrays comprising two or more adder arrays for generating, in a non-cooperative mode, respective product representing values representing multiplication of respective pairs of data elements selected from the first operand and the second operand according to the data element size configuration corresponding to that subset of adder arrays, where in the cooperative mode each of said plurality of subsets of adder arrays is assigned to a part of the multiplication of said wider portions; and
a further adder array to generate a further product representing value representing a result of a remaining part of the multiplication of said wider portions other than the parts assigned to the plurality of subsets of adder arrays; and the multiplication circuitry comprises enable control circuitry to disable the further adder array in the non-cooperative mode.

The plurality of subsets of adder arrays may be the same subsets as the at least two subsets mentioned above that are provided with separate enable control signals.

Hence, in some examples, the support for a larger multiplication in the cooperative mode may require some additional partial products to be added which are not required for any of the data element size configurations supported natively by the plurality of subsets of adder arrays. Hence, a further adder array may be provided (which is disabled in the non-cooperative mode), to compute a further product representing value representing a result of a remaining part of the multiplication of the wider portions being multiplied in the cooperative mode. This further adder array can also share the same Booth encoding circuitry used for the other subsets of adder arrays that are used in the non-cooperative mode.

In some examples, the separate enable control for the adder array may be provided on a subset-by-subset basis, so that each subset of adder arrays corresponding to a given data element size configuration has its own independent enable/disable control, but it is not essential to provide finer grained control to independently enable/disable each individual adder array within a subset. For example, a first subset of adder arrays designed for multiplications based on a first data element size configuration (e.g. 8-bit*8-bit multiplications) could be collectively enabled/disabled based on a single shared enable control signal, with that enable control signal being separate from an enable control signal used to enable/disable a second subset of adder arrays designed for multiplications based on a second data element size configuration (e.g. 16-bit*16-bit multiplications).

However, in other examples each adder array could have its own independent enable control signal, allowing each adder array to be independently enabled/disabled by the enable control signal. This can be useful, for example, for allowing some adder arrays to be disabled (even when the currently selected data element size configuration is the data element size configuration associated with that adder array), for example if a given data element lane of the first/second operands is predicated to disable the effects in that lane. Also, providing independent enable/disable control for the respective adder arrays within a subset of adder arrays designed for a given data element size configuration can also be helpful to allow a set of adder arrays designed to support a certain maximum operand length for the first/second operands to also support multiplications performed on operands of smaller length. For example, while a set of adder arrays could be provided to support 64-bit operands, half of the adder arrays used for a given data element size configuration could be disabled when the multiplication is to be applied to 32-bit operands.

The separate enable control signals for each adder array can be implemented in a variety of ways. For example, power gating could be used to provide separate enable/disable control, by providing the ability to selectively isolate each adder array from a power supply node.

However, in one example, the separate enable control signals comprise separate clock signals. For example, the enable control circuitry described above may clamp the clock signal to a selected adder array to a fixed value when that selected adder array is to be disabled. Holding the clock signal to the selected adder array static may prevent the selected adder array from functioning and may conserve dynamic power. Controlling enabling/disabling of the adder arrays based on whether the corresponding clock signals are allowed to toggle or not can be a more area-efficient way of providing independent enable/disable control for each adder array, as it can require fewer additional logic gates compared to an alternative such a power gating.

An apparatus may comprise processing circuitry to perform data processing in response to instructions; and the processing circuitry comprising the multiplication circuitry described above. For example, the processing circuitry could be a CPU (Central Processing Unit), GPU (Graphics processing unit) or other processing unit within a data processing system (e.g. a Neural Processing Unit provided for performing neural network processing or other machine learning operations).

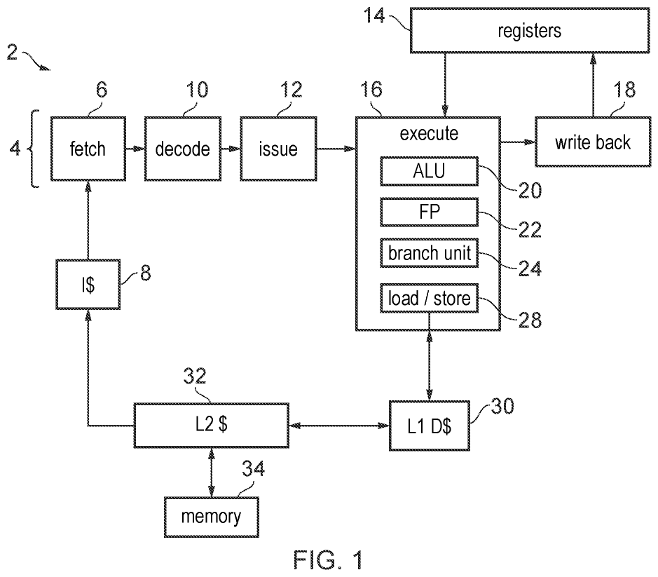

FIG. 1 schematically illustrates an example of a data processing apparatus 2. The data processing apparatus has a processing pipeline 4 (an example of processing circuitry) which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include an integer or fixed-point arithmetic/logic unit (ALU) 20 for performing arithmetic or logical operations on scalar operands or vector operands read from the register file 14; a floating point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

One example of an operation which may be supported by the processing circuitry 4 (e.g. within the ALU 20 or the floating point unit 22) is a multiplication operation. In some systems, a dedicated execution unit called a multiply-accumulate (MAC) unit may be provided to handle multiplications since multiply-accumulate operations (where two operands are multiplied and the result is added to an accumulator value). A multiply-accumulate operation may be frequently used in digital signal processing algorithms for example, so any techniques for improving energy efficiency and reducing pressure to meet circuit timings can be extremely helpful.

While examples below discuss a multiplication operation, this is intended to encompass multiply-add or multiply-accumulate operations, so even if a subsequent adder for adding the multiplication result to a third operand is not shown, such a subsequent adder could still be provided. It is also possible to provide standalone multiplication operations which produce a multiplication result without also adding the multiplication result to a third operand.

The multiplication circuitry 50 described below is based on a technique known as Booth multiplication, which is based on the principle that, when multiplying a first value (a multiplicand M) by a second value (a multiplier R) to obtain a multiplication result M*R, within the multiplicand M a string of consecutive binary 1s can effectively be replaced with a +1 at the bit position one place higher than the upper end of the string and a −1 at the bit position corresponding to the lower end of the string, which can help to reduce many of the partial products to zero and so make processor logic implementation more straightforward. This is analogous to 999 in decimal being equivalent to 1000-1. Hence, if considering a multiplication of 999*R, the “schoolbook” long multiplication approach would carry out a series of additions of partial products 900*R+90*R+9*R. With the Booth approach this could be reduced to 1000*R−1*R. Respective overlapping groups of bits (referred to as “Booth digits” below) of the multiplicand M can be analysed to look for patterns representing the start/end of runs of successive 1s, and this can be used to deduce each multiple of R to be selected as a respective partial product to be added to form the product result.

Booth multiplication involves three stages:

### 1. Booth Encoding the Multiplicand M.

The multiplicand M is logically partitioned into a series of overlapping Booth digits each corresponding to a subset of bits of the multiplicand M. For each Booth digit, the Booth encoder analyses the pattern of bits in that Booth digit and outputs, as a Booth encoding of that Booth digit, a partial product selection indicator which indicates which of a number of different multiples of the multiplier R should be selected as a corresponding partial product to be included in the set of partial products added to produce the multiplication result M*R. Different “radix” versions of the Booth encoding scheme can be provided, where the radix indicates how many bits of the multiplicand M are considered in each Booth digit. Neighbouring Booth digits overlap by 1 bit. The least significant Booth digit is padded with a fixed bit of 0b0 at the lower end. The most significant Booth digit is padded with at least one bit above the most significant bit of M. The padding bits correspond to a sign-extension of the multiplicand.

For example, for a Radix-4 Booth multiplication, each Booth digit comprises 3 bits, and neighbouring Booth digits overlap by 1 bit. For example, for an 8-bit multiplicand M having bits M [7:0], the Booth digits may comprise:
M [1:0]:0b0 (the lower two bits of M concatenated with a fixed value of 0 at the lower end).
M [3:1]
M [5:3]
M [7:5]
3 bits comprising a sign extension of M [7] (e.g. for unsigned values this would be 0b00:M [7] and for signed values represented in two's complement representation all three bits are set equal to M [7]).

The Booth encoder implements hardware circuit logic that, based on the pattern of bits in a given Booth digit, determines which multiple of the multiplier R should be selected for a corresponding partial product. The rules for which multiple to select for a given pattern of bits in a Booth digit are based on whether a run of successive 1s starts or ends within that Booth digit. For example, if all bits are 0 or all bits are 1 within the Booth digit, the multiple to select is 0*R because there is no run of 1s starting or ending within the Booth digit. For Booth digits involving a mix of 0s and 1s, the multiple to select depends on the position where any transition from 0 to 1 or 1 to 0 occurs, so that the multiple implements the combined effect of (i) adding a +R multiple at a bit position one higher than the top bit of any run of successive 1s occurring within the Booth digit and (ii) adding a −R multiple at a bit position corresponding to the bottom bit of any run of successive 1s occurring within the Booth digit. However, as the Booth digits are assessed multiple bits at a time, for Radix-4 or higher-radix Booth encoding, higher multiples of R such as ±2*R are considered to account for the fact that the +R or −R multiple could be injected at different bit positions within the Booth digit. Some worked examples are discussed below for Radix-4 and Radix-8, but it will be appreciated that other radix values could be used. For each Booth digit of the multiplicand M, the Booth encoder outputs a partial product selection indicator indicating which of a set of candidate multiples of the multiplier R should be selected for a corresponding partial product.

### 2. Selection of Partial Products

The required multiples of the multiplier R are prepared (this can be done in parallel with the Booth encoding). For example, for Radix-4 operations, the multiples of R that could be selected for a given Booth digit are: +2*R, +R, 0, −R, −2*R. For Radix-8 the multiples extend from +4*R to −4*R. Hence, partial product selection circuitry may form the multiple values.

Forming the multiple values may include negation of R for forming the negative multiples, left shifting of R to form power-of-2 multiples such as +2*R and +4*R, and, if the radix is such that a non-power of 2 multiple such as +3*R is required, addition of other multiples (e.g. adding +2*R and +R to form the +3*R multiple).

From among the candidate multiples, for a given Booth digit partial product selection circuitry selects one of the multiples, based on the partial product selection indicator provided by the Booth encoder for that given Booth digit.

### 3. Addition of Partial Products

The partial products selected for each Booth digit are added together (with an appropriate alignment between the partial products for adjacent Booth digits to account for the relative magnitude of the partial product based on the position where the Booth digit was found within the multiplicand M).

To illustrate Booth multiplication, consider a multiplication M*R where M and R are both 8-bit values and the decimal values corresponding to M and R are M=56 and R=47:
M=00111000
R=00101111

With a traditional “schoolbook” long multiplication method, this can be converted into a series of partial products as follows (where PPi is +R if the corresponding bit i of M is 1 and is 0 if the corresponding bit i of M is 0):

Add partial products (shifted by 1 each time):

| | |
|---|---|
| PP₀ | 00000000 |
| PP₁ | 00000000 |
| PP₂ | 00000000 |
| PP₃ | 00101111 |
| PP₄ | 00101111 |
| PP₅ | 00101111 |
| PP₆ | 00000000 |
| PP₇ | 00000000 + |
| | 0000101001001000 |
| | = 2632₁₀ = 56*47 |

### 9 Partial Products for 8*8 Bit Multiplication

With the schoolbook approach, the run of successive 1s in M causes three partial products PP3, PP4, PP5 to include +R multiples. With the Booth approach, the same result could have been achieved by adding +R for PP6 and adding-R for PP3, but with Radix-2 (which would correspond to Booth digits each comprising 2 bits), this would not enable the number of partial products to be reduced. Hence, most practical Booth implementations use Radix-4 or higher.

For Radix-4, the Booth digits are selected based on the bits of M as explained earlier, and the encoding rules are as follows:

| Selected Booth | Multiple of R selected |
|---|---|
| digit Mᵢ₊₁, Mᵢ, Mᵢ₋₁ | as Partial Product |
| 000 | 0 |
| 001 | +1 |
| 010 | +1 |
| 011 | +2 |
| 100 | −2 |
| 101 | −1 |
| 110 | −1 |
| 111 | 0 |

Using the same example of M=56 and R=47, the multiple values available for selection for each partial product are:
+2R=01011110
+R=00101111
0=00000000
−R=11010001
−2R=10100010
   and the multiplicand is:
M=00111000

Hence, the Booth digits selected from the multiplicand M, and the corresponding partial products selected for each Booth digit according to the encoding rules shown above are as follows:

BD₀=M₁, M₀, M₋₁=00 (0)->PP₀=0
BD₁->M₃, M₂, M₁=100->PP₁=−2R=10100010
BD₂==M₅, M₄, M₃=111->PP₂=0
BD₃=M₇, M₆, M₅=001->PP₃+R=00101111
BD₄=SE, SE, M₇=000->PP₄=0

Adding partial products (shifted by 2 each time to account for relative alignment of each Booth digit) gives:

| | |
|---|---|
| PP₀ | 00000000 |
| PP₁ | 11111110100010 |
| | (PP₁ sign extended) |
| PP₂ | 00000000 |
| PP₃ | 00101111 |
| PP₄ | 0000000000 + |
| | 0000101001001000 |
| | = 2632₁₀ = 56*47 |

Hence, the same numeric result can now be achieved while adding only 5 partial products, rather than 9.

Similarly, for Radix-8, the Booth encoding rules are as follows:

| Selected Booth | Multiple of R selected |
|---|---|
| digit Mᵢ₊₁, Mᵢ, Mᵢ₋₁ | as Partial product |
| 0000 | 0 |
| 0001 | +1 |
| 0010 | +1 |
| 0011 | +2 |
| 0100 | +2 |
| 0101 | +3 |
| 0110 | +3 |
| 0111 | +4 |
| 1000 | −4 |
| 1001 | −3 |
| 1010 | −3 |
| 1011 | −2 |
| 1100 | −2 |
| 1101 | −1 |
| 1110 | −1 |
| 1111 | 0 |

Applying this to the same M=56 and R=47 example gives:
M=00111000
+4R=10111100
+3R=01110011
+2R=01011110
+R=00101111
0=00000000
−R=11010001
−2R=10100010
−3R=(1) 01110011
−4R=(1) 01000100
BD₀=M₂:M₋₁=000 (0)->PP₀=0
BD₁=M₅:M₂=1110->PP1=−R=11010001
BD₂=M₈:M₅=(0) 001 (bit 8 sign extended from bit 7)->PP2=+R=00101111

Add partial products (shift by 3 each time):

| | |
|---|---|
| PP₀ | 00000000 |
| PP₁ | 11111010001 |
| | (PP₁ sign extended) |
| PP₂ | 00101111 + |
| | 00101001001000 |
| | = 2632₁₀ = 56*47 |

Now the result can be achieved in 3 partial products.

Hence, an approach using a higher radix can treat the multiplicand M as including fewer Booth digits and hence require fewer partial products to be added, but this is at the expense of increased complexity in having more options for the multiple selection (which will increase the circuit complexity of generating the multiple values and the multiplexers which select the multiple, as well as the complexity of the Booth encoder).

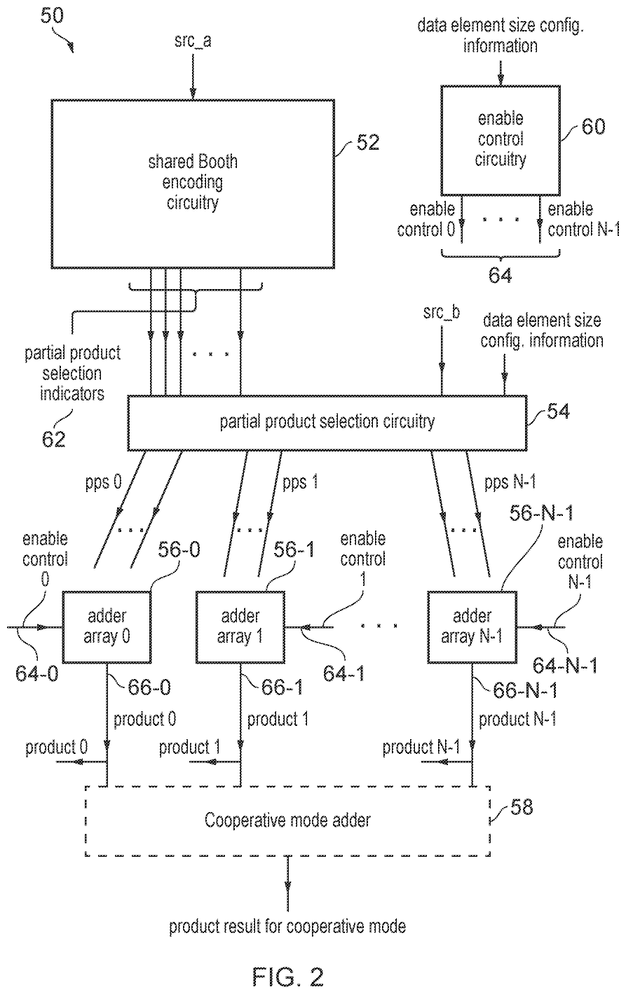

FIG. 2 illustrates an example of multiplication circuitry 50 which can be included within the execute stage 16 of the processor 2 (either within the ALU 20, or within the floating point unit 22, or in another execution unit such as a vector ALU or matrix processing unit separate from an ALU used for scalar operations). The examples below assume that the multiplication operation is performed on data elements having a number of bits equal to a power of 2, which may be common if the operations are performed on integer operands. However, it is not essential for the data elements to have a number of bits corresponding to a power of 2. For example, for multiplications performed on the significands of floating-point operands, the significands may have a non-power-of-2 number of bits because some of the bits of a power-of-2 sized floating-point representation are used for the sign and exponent. Hence, it will be appreciated that the examples below could be adjusted for handling other data element sizes. Also, while the examples below assume the pair of portions of the two operands being multiplied together are of equal number of bits (e.g. a 16-bit*16-bit multiplication, or a 32-bit*32-bit multiplication), this is not essential and it is also possible to provide data element size configurations with asymmetric sized portions being multiplied (e.g. a 16-bit*8-bit multiplication). For example, multiplication circuits with asymmetric operand sizes may be useful for machine learning processing, where for example the kernel weights for a neural network may have fewer bits than the activations being multiplied by the kernel weights.

As shown in FIG. 2, the multiplication circuitry 50 includes shared Booth encoding circuitry 52, partial product selection circuitry 54, a set of adder arrays 56, a cooperative mode adder (also referred to as product adding circuitry) 58 and enable control circuitry 60. The multiplication circuitry 50 receives a first operand src_a, a second operand src_b, and data element size configuration information indicating a data element size configuration to be used for processing the first and second operands src_a, src_b. The first and second operands may be SIMD (single-instruction-multiple-data) operands having a number of independent data elements each representing a separate data value within the same operand. For example, the first and second operands may be vector operands representing a one-dimensional array of independent vector elements, or matrix operands representing a two-dimensional array of independent matrix elements. The first and second operands may be obtained from source registers specified by a multiplication instruction executed by the processing circuitry and/or may be forwarded from a result generated by an earlier instruction in the processing pipeline 4.

For one of the data element size configurations, the first and second operands may be treated as single data elements to be multiplied together, but for other data element size configurations each of the first and second operands may be logically divided into multiple independent data elements and the product result to be generated may be a vector or matrix comprising a number of result data elements each corresponding to the product of a corresponding pair of data elements of the first and second operands. For a given multiply operation, the data element size configuration information may depend on an immediate operand or register operand of an instruction executed by the processing circuitry 4, and/or based on element size mode information stored within the system register of the processing circuitry 4. The data element size configuration information may vary from one multiplication operation to another.

The shared Booth encoding circuitry 52 Booth encodes the first operand src_a, to generate a set of partial product selection indicators 62 which each correspond to a Booth encoding of a respective Booth digit of the first operand. The Booth encoding is generated based on the bit patterns of the corresponding Booth digit, according to the encoding rules shown for radix-4 or radix-8 above (or alternatively, if higher radix is used for the Booth encoding, according to similar rules for that higher radix).

The partial product selection circuitry 54 selects, based on the second operand src_b and the partial product selection indicators 62, the sets of partial products to be added by each of the adder arrays 56. For example, a first set of partial products “pps 0” is selected for adder array 56-0, a second set of partial products “pps 1” is selected for adder array 56-1, and so on. The partial product selection may also depend on the data element size configuration information (e.g. different portions of the second operand src_b may be used to select the partial products, depending on whether the data element size configuration information indicates use of the cooperative mode or non-cooperative mode described further below). For each partial product, the partial product is a selected multiple of a corresponding portion of the second operand src_b, where that multiple can range from +2*R to −2*R for radix-4 and from +4*R to −4*R for radix-8 (where R is the value corresponding to the selected portion of bits of the second operand src_b that is relevant for a given adder array 56). Different adder arrays 56 may have their partial products selected based on different portions of the second operand src_b. As well as selecting the partial products, the partial product selection circuitry 54 may also include circuitry for generating the multiple values available for selection as the partial products—e.g. including shifting circuitry, negation circuitry, and/or adding circuitry to generate the required+2*R to −2*R or +4*R to −4*R multiples for each portion of the second operand src_b. The circuitry for generating the multiple values based on src_b may operate in parallel with the Booth encoding circuitry 52 generating the partial product selection indicators 62 based on the first operand src_a.

Each adder array 56 receives its set of partial products, and when enabled based on a corresponding enable control signal 64 provided by the enable control circuitry 60, adds its partial products to generate a corresponding product representing value 66 which represents a result of multiplication of a respective pair of portion of bits selected from the first operand src_a and the second operand src_b. A given product representing value 66 represents the numeric result M*R of the product of M (a number represented by a selected portion of bits of the first operand src_a) and R (a number represented by a selected portion of bits of the second operand src_b). For each adder array 56, the portions selected from the first and second operands to represent M and R may be different. To speed up addition of partial products, each adder array 56 may be implemented as a carry-save-adder tree which performs a series of carry-save additions (not carry-propagate additions), which reduces processing time by allowing parallel processing of additions in different bit lanes because there is no dependence of the addition in one bit lane on carries generated in lower bit lanes. Therefore, the product representing value 66 for a given adder may be represented in a carry-save representation using a sum term and a carry term. To generate a binary result for M*R in a two's complement representation, this may require a further addition of the sum term and the carry term using a carry-propagate adder (not shown in FIG. 2).

The respective adder arrays 56 are sized to handle different data element configurations within the first and second operands. For example, one subset of adder arrays 56 may implement the additions of partial products for respective pairwise multiplications of pairs of 8-bit data elements within the first and second operands. A second subset of adder arrays 56 may implement the partial products additions for respective pairwise multiplications of pairs of 16-bit data elements within the first and second operands. A third subset of adder arrays 56 may implement the partial products additions for respective pairwise multiplications of pairs of 32-bit data elements within the first and second operands. It will be appreciated that this is just one example of different data element configurations that can be implemented. However, it can be useful to provide separate distinct adder arrays sized appropriate to each data element size configuration, rather than implementing all the data element sizes using a single larger adder array, as this can be more energy efficient because it allows the adder arrays 56 corresponding to data element size configurations not required for a given multiplication operation to be disabled to save power.

In this example, each adder array 56 has its own independent enable control signal 64 which is set independently by the enable control circuitry 60 to independently control whether each adder array is currently enabled or disabled. For example, each enable control signal 64 may be a clock signal used to clock components of the adder array 56, so the enable control circuitry 60 may disable a given adder array by clamping the corresponding clock signal to a fixed value. By preventing the clock signal from toggling, the adder array can be disabled and dynamic power is saved. Other implementations may use a different form of enable control, such as power gating where the enable control signal 64 controls enabling/disabling of the adder array 56 by turning on/off a power gate which controls whether the adder array 56 is coupled to or isolated from a power supply node.

Other examples, may control the independent enable/disable of the adder array at a coarser granularity, on a subset by subset basis. For example, the first, second and third subsets of adder arrays 56 described above could each be provided with an independent enable control signal 64, but adder arrays within the same subset could be enabled/disabled collectively based on the same enable control signal. However, in practice, having independent enable/disable control for each adder array 56 as shown in the example of FIG. 2 can offer greater opportunities for power savings, e.g. by allowing adder arrays 56 corresponding to masked data elements of the first/second operands (elements which are masked by predication) to be disabled to save power, or by allowing adder arrays 56 within a subset to be disabled when they are not required for a multiplication operation applied to operands of operand length shorter than the maximum size supported.

The respective adder arrays 56 can also be used cooperatively to implement a larger multiplication, such as the multiplication of wider portions of bits of src_a and src_b which comprise all magnitude-indicating bits of the first and second operands. When the data element size configuration information indicates that the cooperative mode is to be used, the respective products representing values 66 produced by at least a subset of adder arrays (e.g. all of the adder arrays) are added together by the cooperative mode adder 58, to produce a product results indicating the numeric value corresponds the product of the wider portions of src_a and src_b than the portions considered by any individual adder array. For example, in the implementation discussed in more detail below, the cooperative mode implements a 64-bit*64-bit multiplication, by adding the product representing values 66 generated by the various adder arrays 56 which in a non-cooperative mode would handle smaller 8-bit, 16-bit or 32-bit multiplications, as well as a further product representing value generated by a further adder array 56 which handles spare bits of the 64-bit multiplication that are not covered by the other adder arrays 56.

Hence, a larger adder array for a multiplier is constructed from a number of smaller (sub) arrays 56. Some of the smaller subarrays are sized (in terms of power and area) for multiplying smaller data types in a non-cooperative mode. The subarrays 56 can also be used cooperatively to construct larger logical arrays (e.g. for the largest data type).

In the examples discussed below, it is recognised that there is an opportunity to save area by realizing that the subarrays 56 depend on Booth encoding of the same operand src_a or the same subsections of that operand src_a. They do this regardless of whether they are running native sized multiplications in the non-cooperative mode or working collectively to compute the larger datatype in the cooperative mode. An area and timing pressure reducing solution is to pull Booth encoders out of each subarray and implement one set of Booth encoders (collectively referred to as shared Booth encoding circuitry 52) shared between all the adder arrays 56, so that at least two of the adder arrays each receive a partial product selected based on the same partial product selection indicator 62 corresponding to a Booth encoding of a same Booth digit generated by the same set of hardware circuit logic in the shared Booth encoding circuitry.

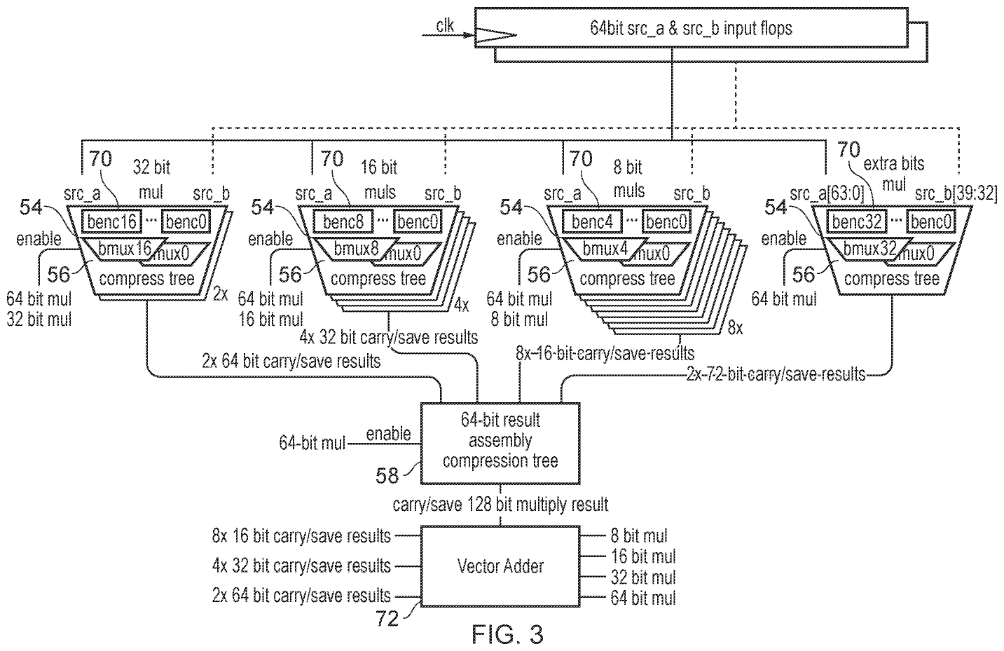

For comparison, FIG. 3 shows an alternative approach based on private Booth encoding circuitry specific to each adder array 56. In this example, there are 2 32-bit adder arrays 56, 4 16-bit adder arrays 56 and 8 8-bit adder arrays 56 dedicated to handle partial product additions for 32*32-bit, 16*16-bit and 8*8-bit multiplications respectively. There is also an “extra bits” adder array 56 which adds portions of src_a and src_b that are only required for a cooperative 64-bit multiplication. Each adder array 56 has a corresponding portion of the partial product selection circuitry 54 (comprising multiplexers for selecting each partial product to be added by that adder array). Each adder array 56 also has its own private instance of Booth encoding circuitry 70 for Booth encoding the first operand src_a to generate the partial product selection indicators used by the partial product selection circuitry 54 to select the partial products for that adder array 56. There is no sharing of Booth encoders between adder arrays—each adder array 56 receives partial products selected based on Booth encodings generated by a separate piece of hardware circuit logic not used by any other adder array 56.

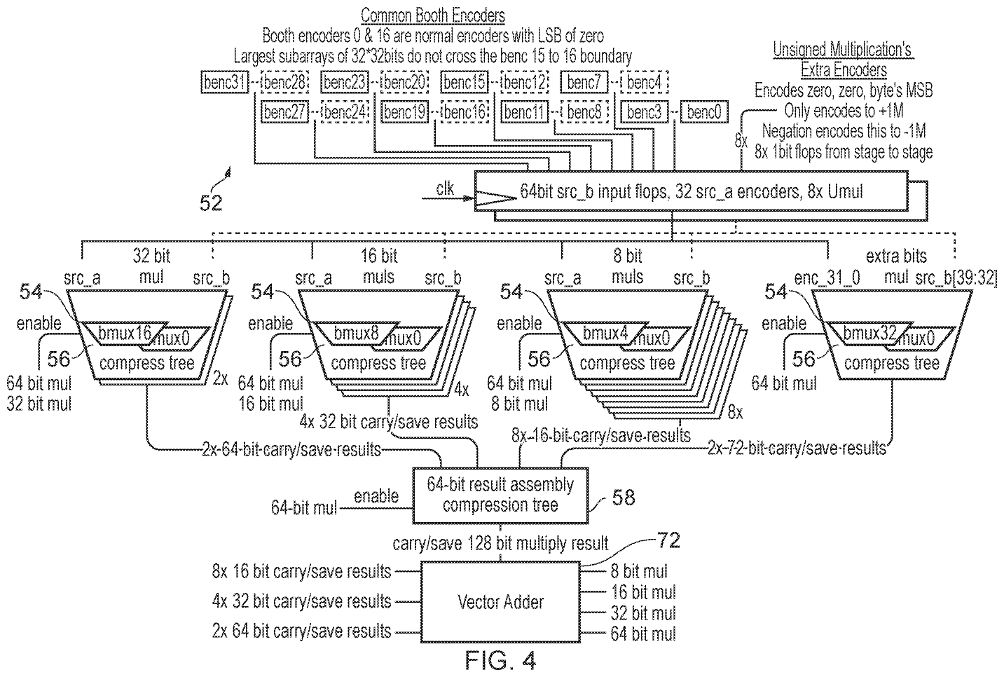

When the data element size configuration to be used is 8-bit, 16-bit or 32-bit, the corresponding subset of adder arrays is enabled and each adder array within that subset receives partial products selected depending on a corresponding pair of Aug. 16, 1932-bit data elements within the first and second operands src_a, src_b. The results of each adder array can be assembled into a vector result (e.g. by result assembly circuitry 58 which in FIG. 4 is indicated as a single unit shared with the compression tree implementing the cooperative mode adder 58 shown in FIG. 2). In the non-cooperative mode, adder arrays corresponding to a data element size configuration that is not in use can be disabled by the enable control circuitry 60 to save power. Optionally adder arrays corresponding to a data element size configuration that is in use could also be disabled, e.g. if the corresponding data elements they act on are masked by predication or are not required due to operating on a shorter operand length than the maximum operand length supported.

It is possible to operate the adder arrays so that the subsets of adder arrays for more than one of the data element size configurations are enabled in parallel, to produce (based on the same source operands src_a, src_b) a first vector result corresponding to one size configuration (e.g. 32-bit) and a second vector result corresponding to a second size configuration (e.g. 16-bit). This may require the result assembly circuitry to be duplicated to allow for output of multiple independent results in the same cycle.

In the 64-bit cooperative configuration, all the adder arrays are enabled, and the respective product representing values 66 generated by the adder arrays are further added by cooperative mode adder 58 to produce a 64-bit multiplication result. Optionally, for a multiply-accumulate operation, a further adder 72 may add the multiplication result (or multiplication results for each data element lane) to corresponding elements of a third operand (still in carry save form to speed up the further adder 72 compared to carry propagate additions).

Optionally, the carry and save terms output by the result assembly circuitry, cooperative mode adder 58 or further adder 72 can be added by a carry propagate adder to produce a result in 2's complement representation, but this is not essential as often the multiply operation may be one of a series of multiply-accumulate operations and so it may be more efficient to retain the result in carry-save form to allow the further adder 72 to perform a faster addition to a previous accumulation result also in carry-save form (with the carry-propagate operation for converting to 2's complement being deferred until after the final accumulation is performed).

In contrast, FIG. 4 illustrates an implementation where the Booth encoders for each of the adder arrays 56 are pulled out of the adder arrays 56 and are shared across all adder arrays 56. Other than the sharing of Booth encoders, the partial production selection circuitry 54 and adder trees 56, result assembly circuitry/cooperative mode adder 58 and vector adder 72 are the same as in FIG. 3 and so these features of FIG. 4 are as discussed above for FIG. 3.

As the Booth encoders are shared between adder arrays, this means that more than one adder array 56 receives a partial product selected using the same partial product selection indicator generated by the same Booth encoder (same piece of hardware circuit logic). It is recognised that all subarrays 56 should receive partial products based on Booth encodings of the same sections or subsections of one input operand src_a, and so there can be one set global Booth encoders across the 64-bit input operand. These shared global Booth encoders feed each of the 15 subarray multipliers. When Booth encoders are shared between adder arrays 56 supporting different data element size configurations, the Booth digits that span a data element boundary in one configuration but are at an intermediate point within a data element for another configuration may require different input bits for different element size configurations. Hence, for example, for the 8-bit boundaries within the first operand, there are special Booth encoders that have selection logic to select whether a lower bit of the Booth digit is treated as 0 or is selected from src_a. This is described in more detail below.

The sharing of Booth encoders between adder arrays 56 enables a great circuit area and power saving. In the approach shown in FIG. 3, for supporting signed multiplication operations, the eight 8-bit multipliers have 5 private Booth encoders each; the four 16-bit multipliers have 9 private Booth encoders each; the two 32-bit multipliers have 17 private Booth encoders each; and the extra bits multiplier has 33 private Booth encoders. Hence, in total there are 143 private booth encoders.

In contrast, in FIG. 4 with shared global Booth encoders feeding all 15 adder arrays, there are now 32 Booth encoders for supporting signed multiplication (plus 8 smaller Booth encoders used for unsigned multiplication which are described further below). This represents a large area reduction compared to FIG. 3.

The large decrease in encoders also enables a flop stage to be economically split between Booth encoding 52, Booth multiplexing (partial product selection 54) and partial product compression (addition of partial products 56). Previously 143 sets of Booth encoded values would need to be flopped to split here, now only 32 need to be flopped (plus 8 single bit flops for unsigned multiplication). This is a similar size to flopping the encoded 64-bit operand, which no longer needs to be encoded in a second flop stage due to the large numbers of flops required to do so. This is the timing pressure reduction this technique enables.

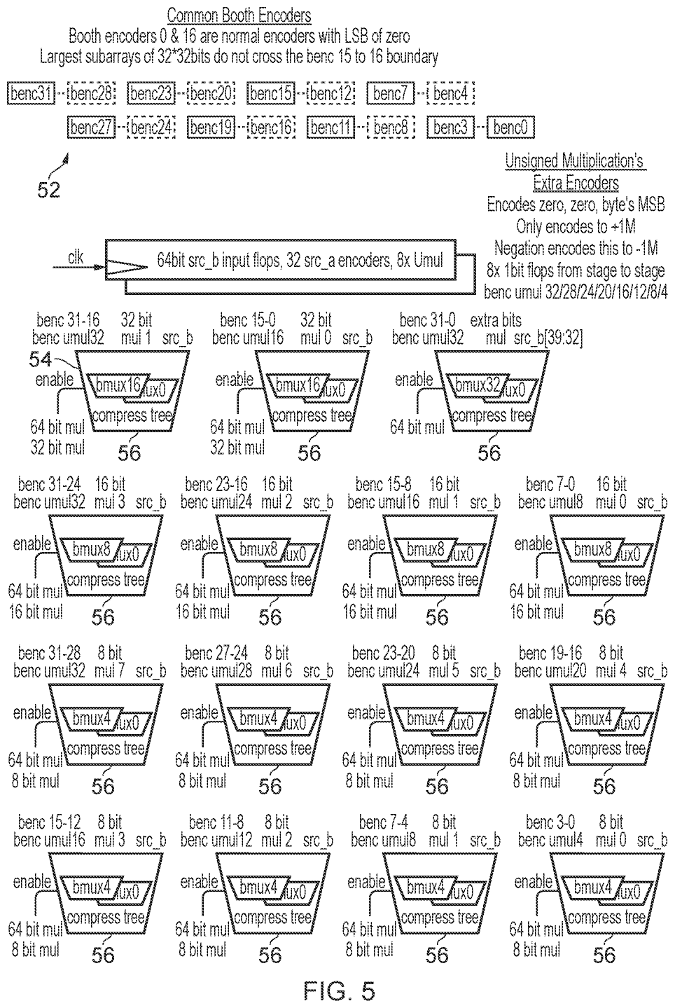

FIGS. 5 to 12 illustrate the multiplication circuitry 50 in more detail, for an example implementing Radix-4 Booth multiplication (it will be appreciated that other examples could use higher radix). FIG. 5 illustrates the same adder arrays 56 and shared Booth encoding circuitry 52 as in FIG. 4, but with each subset of adder arrays (the 32-bit subset, the 16-bit subset and the 8-bit subset) expanded to show the individual adder arrays 56 in each subset. Hence, there are two 32-bit adder arrays 56, four 16-bit adder arrays, eight 8-bit adder arrays, as well as the “extra bits” adder array 56 which is used in the cooperative 64-bit mode. The enable control inputs for each adder array 56 are labelled in FIG. 5 to show the data element size configurations for which that adder array is enabled. Hence, the 8-bit adder arrays are enabled for 8-bit and 64-bit configurations but can be disabled for 16-bit and 32-bit configurations, the 16-bit adder arrays are enabled for 16-bit and 64-bit configurations but can be disabled for 8-bit and 32-bit configurations, and the 32-bit adder arrays are enabled for 32-bit and 64-bit configurations but can be disabled for 8-bit and 16-bit configurations. Individual adder arrays could also be disabled even when the currently selected configuration is one for which that adder array is relevant, if that adder array is not required because the corresponding data elements of the first/second operands are masked by predication for example.

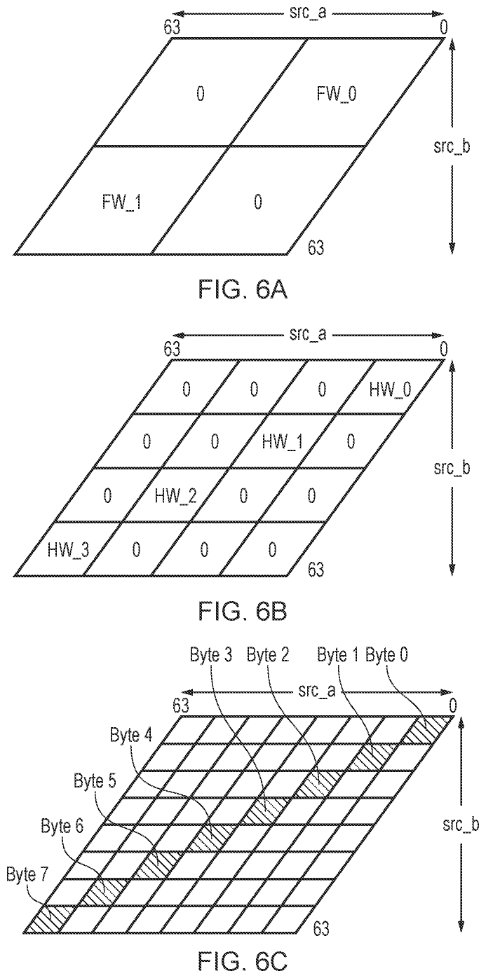

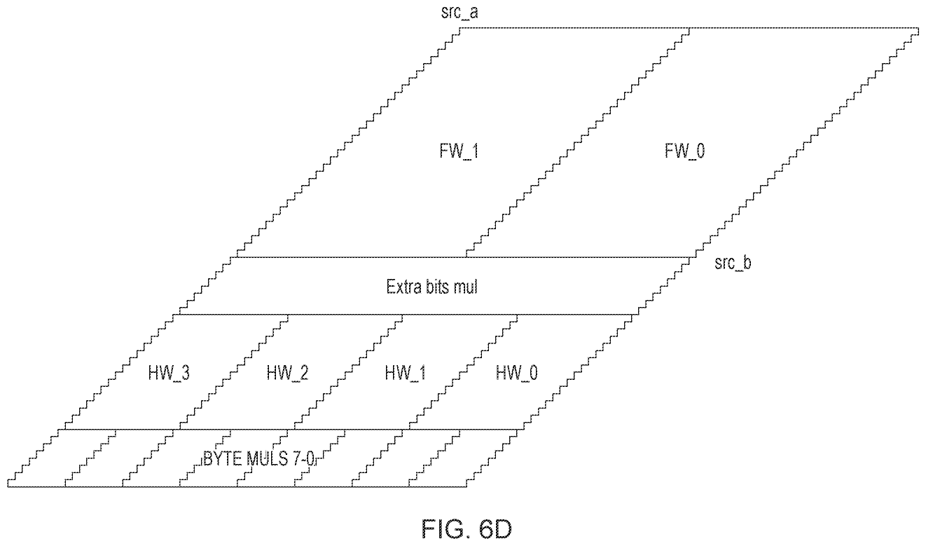

FIGS. 6A to 6D illustrate how the adder arrays 56 are assigned respective portions of the first and second operands src_a, src_b to be multiplied based on the additions of partial products by each adder array. Each diagram is shown as a rhombus where the top edge of the rhombus represents the bits of the first operand src_a and the right hand edge of the rhombus represents the bits of the second operand src_b, with each operand src_a, src_b having 64 bits. The rhombus shape represents the partial product additions that would be performed if a full-width 64-bit*64-bit multiplication was performed using a traditional “schoolbook” long multiplication method (adding 64 partial products, offset by 1 bit between each row, corresponding to src_a if the corresponding bit of src_b is 1 and corresponding to 0 if the corresponding bit of src_b is 0). It will be appreciated that, as a Booth multiplication scheme is used, the adder arrays do not actually add 64 partial products in this way, but it is useful to consider a theoretical example which adds 64 partial products to explore how the portions of src_a and src_b are mapped to the adder arrays.

FIG. 6A illustrates a mapping of the adder arrays in the 32-bit data element size configuration. In this case, the 64-bit operands src_a and src_b are treated as a pair of 32-bit data elements and the two 32-bit adder arrays (32-bit mul 0 and 32-bit mul 1) are assigned to add the partial products corresponding to respective full-word (32-bit) multiplications FW_0 and FW_1 respectively, where FW_0 corresponds to a multiplication of the lower elements src_a [31:0] and src_b [31:0] and FW_1 corresponds to a multiplication of the upper elements src_a [63:32] and src_b [63:32]. As explained further below, the regions denoted with “0” in FIG. 6A are not assigned to any of the adder arrays 56.

FIG. 6B illustrates a mapping of the adder arrays in the 16-bit data element size configuration. In this case, the 64-bit operands src_a and src_b are treated as four 16-bit data elements each and the four 16-bit adder arrays (16-bit mul 0 to 16-bit mul 3) are assigned to add the partial products corresponding to four respective half-word (16-bit) multiplications HW_0 to HW_3 respectively, where HW_0 corresponds to a multiplication of the lower elements src_a [15:0] and src_b [15:0], HW_1 corresponds to a multiplication of the next lowest pair of elements src_a [31:16] and src_b [31:16], HW_2 corresponds to a multiplication of the second highest pair of elements src_a [47:32] and src_b [47:32], and HW_3 corresponds to a multiplication of the upper elements src_a [63:48] and src_b [63:48].

FIG. 6C illustrates a mapping of the adder arrays in the 8-bit data element size configuration. In this case, the 64-bit operands src_a and src_b are treated as eight 8-bit data elements each and the eight 8-bit adder arrays (8-bit mul 0 to 8-bit mul 7) are assigned to add the partial products corresponding to eight respective byte multiplications Byte0 to Byte7 respectively (each operating on a respective pair of 8-bit elements within src_a and src_b).

The 8-bit, 16 bit and 32-bit configurations are examples of non-cooperative modes as each adder array produces an independent product representing value which (subject to assembly into a vector result value and possible conversion from carry-save form to 2's complement), does not require further additions with other product representing values to produce a multiplication result.

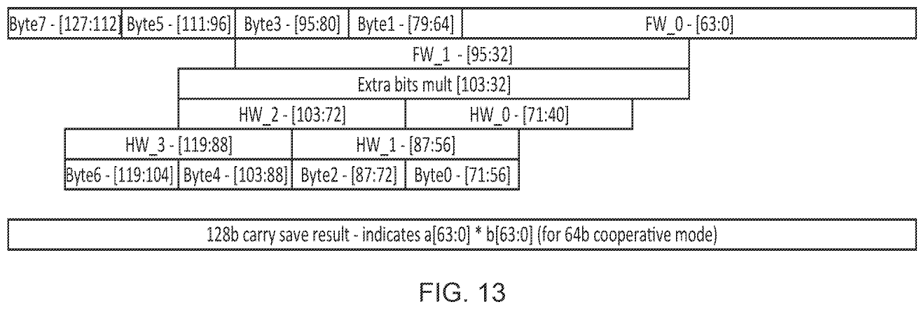

In contrast, FIG. 6D shows a cooperative mode where the adder arrays 56 are used together to produce respective product representing values representing sub-portions of a wider 64-bit*64-bit multiplication. The respective product representing values from each adder array can be added together (with appropriate bit lane offsets depending on the relative position of the corresponding adder array's portion of the multiplication within the 64-bit multiplication “rhombus” shown in FIG. 6D), to produce a result value representing the product of the 64-bit portions of src_a and src_b. The relative alignment in the addition of the product representing values is discussed in more detail with respect to FIG. 13 below.

FIG. 6D shows how each of the adder arrays 56 is mapped onto a portion of the 64-bit multiplication. The two full word (32-bit) adder arrays implement the portions of the multiplication corresponding to src_a [31:0] *src_b [31:0] and src_a [63:32] *src_b [31:0] respectively. The four half word (16-bit) adder arrays implement the portions of the multiplication corresponding to src_a [15:0] *src_b [55:40], src_a [31:16] *src_b [55:40], src_a [47:32] *src_b [55:40] and src_a [63:48] *src_b [55:40] respectively. The eight byte-multiplication (8-bit) adder arrays implement the portions of the 64-bit multiplication corresponding to src_a [7:0] *src_b [63:55], src_a [15:8] *src_b [63:55], src_a [23:16] *src_b [63:55], src_a [31:24] *src_b [63:55], src_a [39:32] *src_b [63:55], src_a [47:40] *src_b [63:55], src_a [55:48] *src_b [63:55] and src_a [63:56] *src_b [63:55] respectively. This leaves a portion of extra bits that is not covered by the 8-bit, 16-bit and 32-bit adder arrays, and so the extra bits adder array performs for the partial product additions corresponding to the remaining portion src_a [63:0] *src_b [39:32] not covered elsewhere.

It will be appreciated that FIG. 6D shows just one way in which the required partial product additions for a 64-bit multiplication could be partitioned up between the respective adder arrays. Other examples could map the individual 8-bit, 16-bit or 32-bit adder arrays in a different manner, so that the “extra bits” spare could be used for a region other than the src_a [63:0] *src_b [39:32] region shown in FIG. 6D.

FIGS. 6A to 6D also help to illustrate an advantage of the approach discussed above with separate independently enabled/disabled subsets of adder arrays targeting specific data element size configurations. An alternative would be to provide a single large monolithic adder array with sufficient adder elements and operand widths that it is sized capable of handling 64-bit*64-bit multiplications. Such a large 64-bit adder array could then also be reused to implement smaller 8-bit*8-bit, 16-bit*16-bit or 32-bit*32-bit multiplications by ensuring that all partial product bits corresponding to the regions marked 0 in FIGS. 6A and 6B (and corresponding to the unshaded regions in FIG. 6C) are set to 0 when input into the 64-bit multiplication adder array. In a carry-save adder tree, there is no propagation of carries between lanes, and so within the end 64-bit result output by the adder tree, each lane of additions remains independent. This means that if the only non-zero partial product bits are in the regions marked FW_0 and FW_1 (for FIG. 6A), HW_0 to HW_3 (for FIG. 6B), and Byte0 to Byte7 (in FIG. 6C), the result is effectively a vector of multiplication results. However, a disadvantage with this approach is that even though some portions of the partial products have been set to 0, it is still necessary for the adder elements in some of the portions of the multiplication marked “0” to propagate through bits added in earlier rows of the adder array where there were non-zero bits. For example, the region marked 0 corresponding to src_a [31:0] *src_b [63:32] in FIG. 6A would still need to propagate through results of additions in the region marked FW_0. Hence, even in supposedly “unused” portions of the large monolithic adder array, the adder elements of the adder array may still need to be enabled (powered and clocked) to allow the final multiplication result to correctly represent the element-by-element vector multiplication result.

In contrast, with the approach shown in FIGS. 2, 4 and 5, where adder arrays targeting a smaller element size can be sized according to a specific data element size configuration and independently enabled/disabled by the enable control circuitry 60 separate from adder arrays implementing another data element size configuration, power can be saved by disabling unused adder arrays. It is only when the cooperative mode is selected to perform a full 64-bit multiplication that all the adder arrays are enabled. Hence, a more energy efficient multiplication circuit supporting multiple data element size configurations is possible than with a single 64-bit monolithic adder array.

Hence, while FIGS. 6A to 6C show regions of the multiplication corresponding to “0” (or unshaded) for ease of understanding, it will be appreciated that in the multiplication circuitry 50 described above, there is no need for any additions to take place at all for those 0 regions—by using smaller natively sized adder arrays and disabling other adder arrays not needed for the current data element size configuration selected for a given multiplication operation, power can be saved.

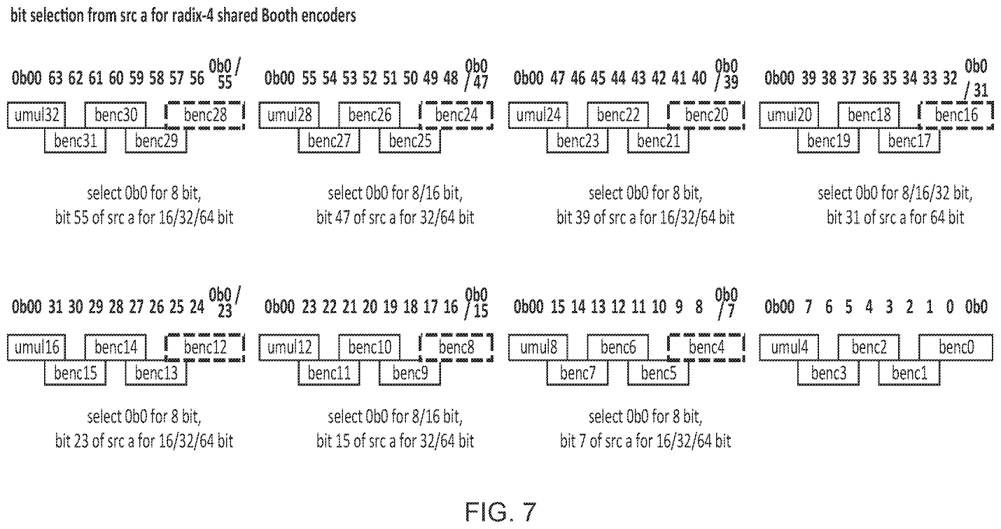

FIG. 7 illustrates the shared Booth encoding circuitry 52 and the mapping of the Booth digits encoded by the Booth encoding circuitry 52 onto the respective bits [63:0] of the first operand src_a. The shared Booth encoding circuitry 52 includes 32 Booth encoders benc0 to benc31 which each generate a corresponding partial product selection indicator indicating the Booth encoding of a corresponding Booth digit of the source operand src_a. The positions of the bits encoded by each Booth encoder are shown in FIG. 7. For example, Booth encoder benc10 encodes bits [21:19] of src_a, and Booth encoder benc11 encodes bits [23:21] of src_a. It can be seen that there is an overlap of 1 bit between the respective Booth digits encoded by successive Booth encoders.

At the lowest Booth digit in each data element, the bottom bit of the Booth digit is 0. When considering the different element size configurations, the Booth digits encoded by Booth encoders benc4, benc8, benc12, benc20, benc24, benc28 span a data element boundary for at least one data element size configuration, but are at an intermediate position within an element for at least one other data element size configuration. Also, the Booth digit encoded by Booth encoder benc16 spans data element boundaries for each of the 8-bit, 16-bit and 32-bit configurations, but is at the intermediate position within the 64-bit values being multiplied when the cooperative 64-bit configuration is selected. Therefore, the Booth encoders marked with dashed lines have selection circuitry to select whether the bottom bit of that Booth digit is either a fixed value of 0b0 (used for data element size configurations where that Booth digit spans a data element boundary) or is the top bit of the next least significant 8-bit portion of src_a (used for data element size configurations where that Booth digit is at an intermediate position within a data element not spanning a data element boundary). The text under each 8-bit portion in FIG. 7 illustrates in more detail which configurations cause 0b0 to be selected and which configurations cause the top bit of the next lowest 8-bit portion of src_a to be selected. The other Booth encoders shown with solid lines do not have such selection circuitry and can Booth encode a fixed subset of bits as shown in the mapping in FIG. 7.

For each Booth encoder benc0 to benc31, the Booth encoder generates a partial product selection indicator to indicate which multiple of a corresponding portion of the second operand should be selected as a partial product, according to the Booth encoding rules for Radix 4:

| Selected Booth | Multiple of R selected |
|---|---|
| digit Mᵢ₊₁, Mᵢ, Mᵢ₋₁ | as Partial Product |
| 000 | 0 |
| 001 | +1 |
| 010 | +1 |
| 011 | +2 |
| 100 | −2 |
| 101 | −1 |
| 110 | −1 |
| 111 | 0 |

If the multiplication operation is being performed on signed values represented in two's complement format, the top bit of each element will be a sign bit. Hence, for an example using Radix-4 assuming data element sizes having a power-of-2 number of bits, although nominally each data element would require one further Booth digit to be encoded corresponding to a sign extension of the top bit of that data element, that further Booth digit would always have a value of 000 and 111 (as the sign extension causes the top bit of the data element to be copied to the other two bits of the Booth digit), and so this would not require any further partial product to be added as the Booth encoding rules shown above give a multiple of 0 for both 000 and 111. Therefore, if only signed multiplications are to be supported, for the Radix-4 example it is sufficient to use the Booth encoders benc0 to benc31 shown in FIG. 7.

However, if unsigned multiplications are to be supported for Radix-4, then the top bit of each element could be 0 or 1 and is padded with 0s (not sign extension bits) to form the top Booth digit in each data element. This means the possible values for the top Booth digit in each element are 000 or 001, and so as the 001 alternative requires an addition of a +1*R multiple, a further partial product may be needed. Therefore, to support unsigned multiplications with the smallest data element size configuration for the 8-bit example, each 8-bit portion of the first operand src_a is also provided with a further unsigned Booth encoder “umul”-hence there are 8 such unsigned Booth encoders, labelled umul4, umul8, umul12, umul16, umul20, umul24, umul28, umul32 respectively (the numbers used to label the unsigned Booth encoders umul4-umul28 being chosen to denote that the Booth digits encoded by these unsigned Booth encoders are of equivalent significance to the Booth digits encoded by Booth encoders benc4, benc8, benc12, benc16, benc20, benc24, benc28 respectively and that umul32 is encoding a Booth digit more significant than the Booth digit encoded by benc31). Each unsigned Booth encoder can have simpler hardware circuit logic than the other Booth encoders benc0-benc31, because it only needs to select from two options (0 or +1*R) based on whether the top bit of the corresponding 8-bit portion of src_a is 0 or 1 respectively.

On the other hand, if a higher radix (e.g. Radix-8) was used, or if Radix-4 was applied to data elements of a size other than an exact power of 2, then depending on the Radix and the data element size used, some Booth digits could be aligned relative to the element boundary so that the further Booth digit which represents a sign-extension of the top bits of the data element could include two or more bits of src_a, not just one bit of src_a as in the Radix-4 example of FIG. 7. In this case, the most significant Booth digit in a given data element could have a Booth encoding which corresponds to a multiple other than 0, even for signed multiplications, and in that case the unsigned Booth encoders umul for the most significant Booth digit in each data element could be replaced with full Booth encoders similar to the benc examples shown for the less significant Booth digits in a data element.

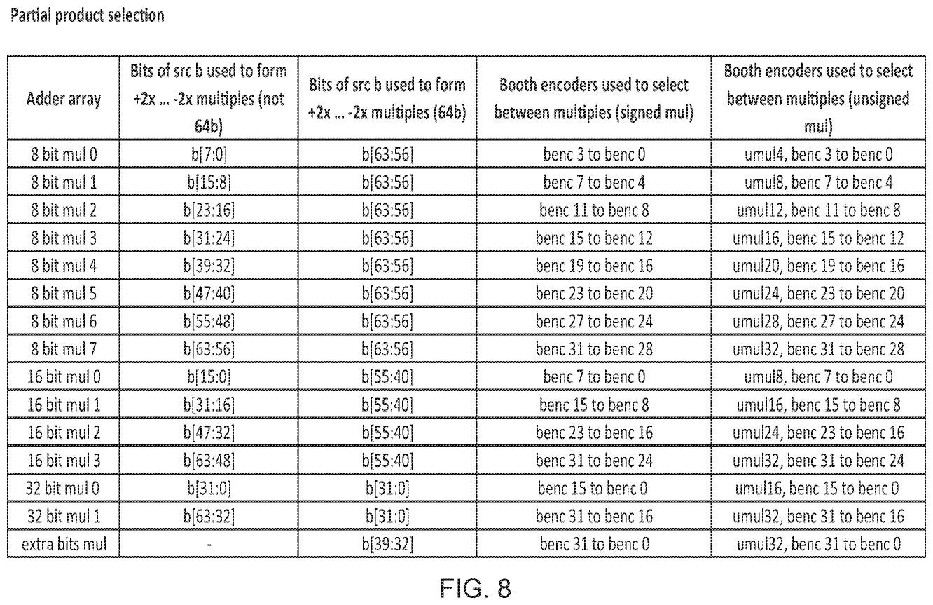

FIG. 8 is a table summarising the partial product selection performed by partial product selection circuitry 54. For each adder array 56, the table indicates which bits of src_b are used to form the partial products to be added by that adder array 56 in the non-cooperative mode (labelled “not 64b”, referring to the 8-bit, 16-bit or 32-bit configurations) and cooperative mode (labelled “64b”) respectively. It can be seen that each adder array has its partial products selected based on different portions of bits of src_b depending on whether a non-cooperative mode or the cooperative mode is used, and that the selected portions of src_b correspond to the mappings shown in FIGS. 6A to 6D for the respective data element size configurations.

FIG. 8 also indicates, for each adder array, which Booth encoders are used to select each partial product, for both a signed multiplication (where the unsigned Booth encoders umul can be ignored by setting the corresponding partial products to 0) and an unsigned multiplication (where each adder array also considers a partial product selected by a corresponding one of the unsigned Booth encoders).

For example, for adder array “8 bit mul 0”, the Booth encoders used are benc 3, benc2, benc1, benc0 (and for an unsigned multiplication, umul4). It can be seen from FIG. 7 that this means the partial products are selected based on Booth encodings derived from src_a [7:0]. This corresponds to the “Byte0” region of the multiplication shown in FIG. 6C (in the 8-bit size configuration where the partial products are based on src_b [7:0]) or FIG. 6D (for the 64-bit cooperative size configuration where the partial products are based on src_b [63:56]).

Note that the extra bit adder array 56 uses all the Booth encoders benc31 to benc0 (because it is mapped in FIG. 6D to the “extra bits mul” region which requires all 64 bits of src_a). For each other adder array 56, only a proper subset of the Booth encoders are used.

However, it can be seen that each of the other adder arrays can be considered to be part of a subset of adder arrays corresponding to a particular data element size configuration (e.g. the 8-bit adder array subset comprising 8 bit mul0 to 8 bit mul 3, the 16-bit adder array subset comprising 16 bit mul 0 to 16 bit mul 3 and the 32-bit adder array subset comprising 32 bit mul 0 and 32 bit mul 1) and that within a given one of these subsets, the adder arrays of that subset collectively use all the Booth encoders benc31 to benc0 but any one adder array of that subset only uses some of those Booth encoders. Each adder array of the 8-bit, 16-bit and 32-bit subsets also uses one unsigned Booth encoder to support unsigned multiplication.

Note also the sharing of the Booth encoders between the subsets of the adder arrays. Any given one of the Booth encoders benc0 to benc31 is used by one adder array in each subset. For example, Booth encoder benc0 is used by 8 bit mul 0, 16 bit mul 0 and 32 bit mul 0 (as well as by the extra bits mul adder array). Booth encoder benc27 is used by 8 bit mul 6, 16 bit mul 3 and 32 bit mul 1 (as well as by the extra bits mul adder array). Hence, there are several adder arrays which each receive a respective partial product which is selected based on exactly the same partial product selection indicator generated by a same Booth encoder (i.e. a same piece of hardware circuit logic) of the shared Booth encoding circuitry. This greatly reduces the amount of hardware circuit area required to implement the Booth encoders compared to the non-shared approach shown in FIG. 3.

Note that the specific mapping of the adder arrays shown in FIG. 6D has the advantage that the selection of which bits of src_a are encoded by the Booth encoders for a given adder array does not need to vary depending on whether the cooperative mode or non-cooperative mode is selected. To avoid needing selection circuitry at each Booth encoder to vary selection of src_a bits based on the cooperative/non-cooperative mode, it would also be possible to select other mappings which retain the src_a allocations shown in FIG. 6D but switch which portions of src_b are assigned to each adder array 56 (e.g. switching the order of some of the rows shown in FIG. 6D).

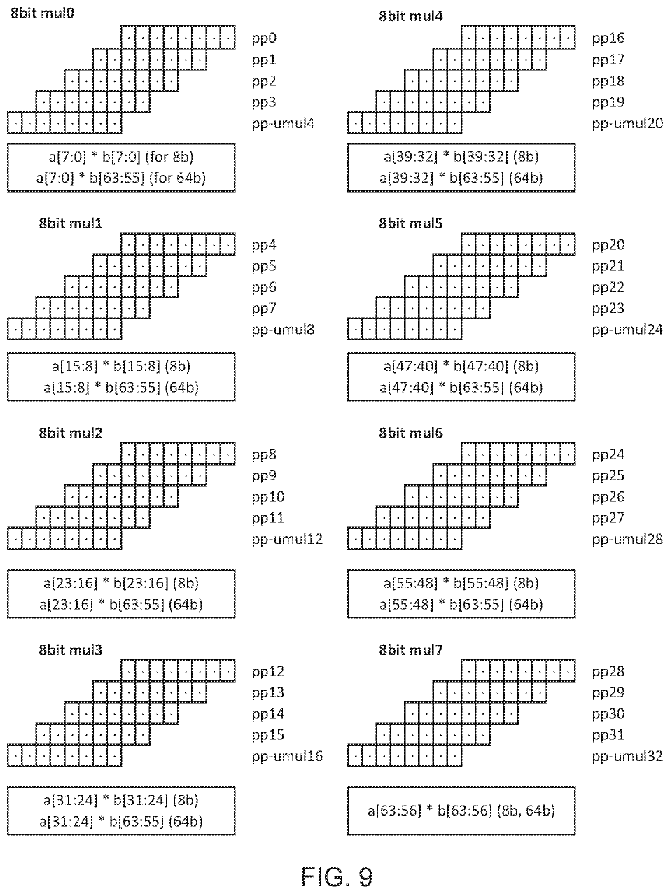

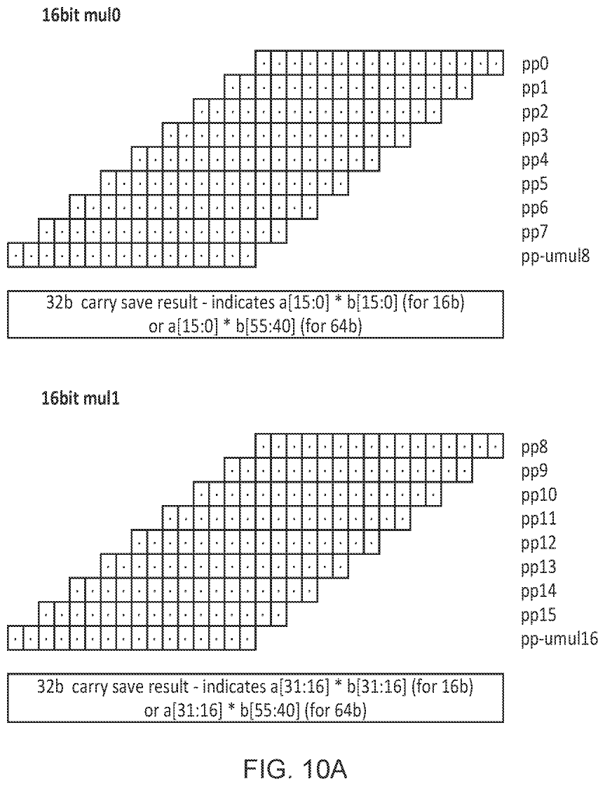

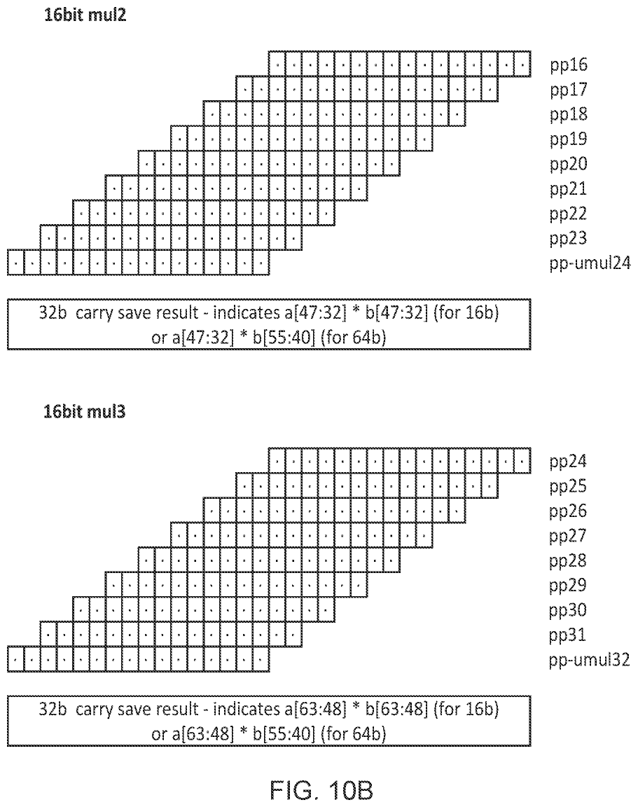

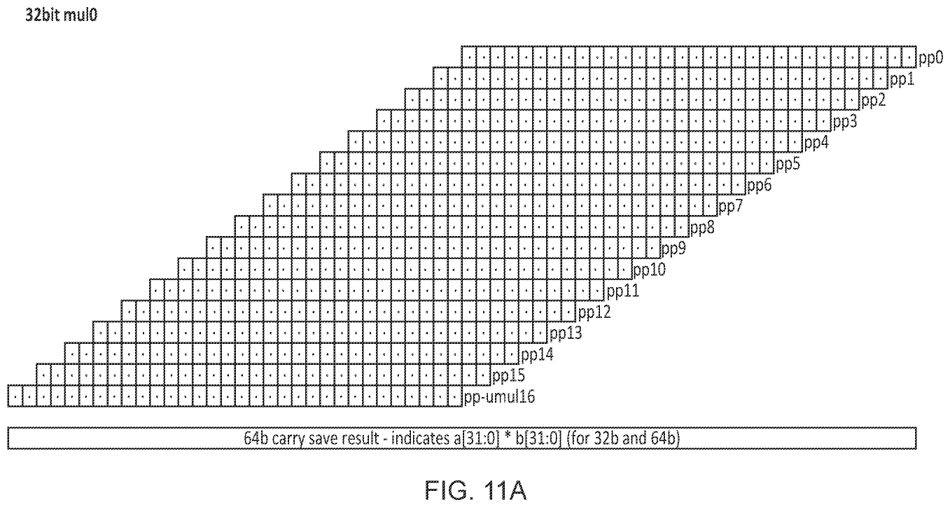

FIG. 9 illustrates in more detail the partial product additions performed by each of the 8-bit adder arrays. Each of the 8-bit adder arrays has a carry-save-adder tree with sufficient number of stages and sufficient bit width to add 5 8-bit partial products (with a 2-bit offset in the alignment between successive partial products, given the radix-4 Booth multiplication implementation—this would be a 3-bit offset for Radix-8), to produce a 16-bit result as the product representing value of that adder array (represented as a 16-bit carry term and a 16-bit sum term according to a carry-save representation). For each 8-bit adder array 56, the 5 partial products added at each row of the adder array are labelled in FIG. 9, where the notation ppi (i=0 . . . 31) refers to the partial product selected based on the partial product selection indicator output by Booth encoder benci, and pp-umulj refers to the partial product selected based on the partial product selection indicator output by unsigned Booth encoder umulj (j is one of 4, 8, 12, 16, 20, 24, 28, 32). The same convention is used for the partial product labels for each of FIGS. 10A, 10B, 11A, 11B and 12.

FIGS. 10A and 10B illustrate in more detail the partial product additions performed by each of the 16-bit adder arrays. Each of the 16-bit adder arrays has a carry-save-adder tree with sufficient number of stages and sufficient bit width to add 9 16-bit partial products (again with a 2-bit offset between adjacent partial products), to produce a 32-bit product representing value in carry-save representation.

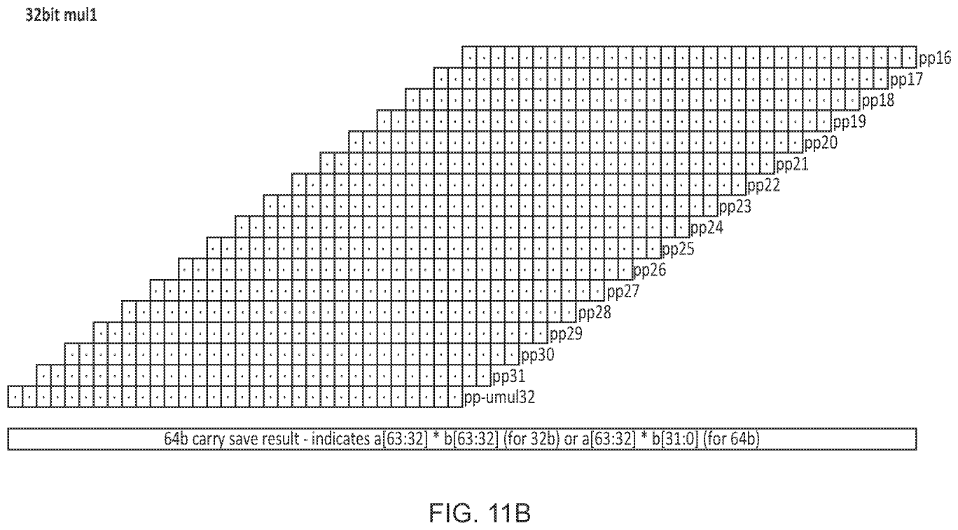

FIGS. 11A and 11B show similar partial product additions for the 32-bit adder arrays, this time adding 17 32-bit partial products (offset by 2-bits between each row) to produce a 64-bit carry-save result as the corresponding product representing value.

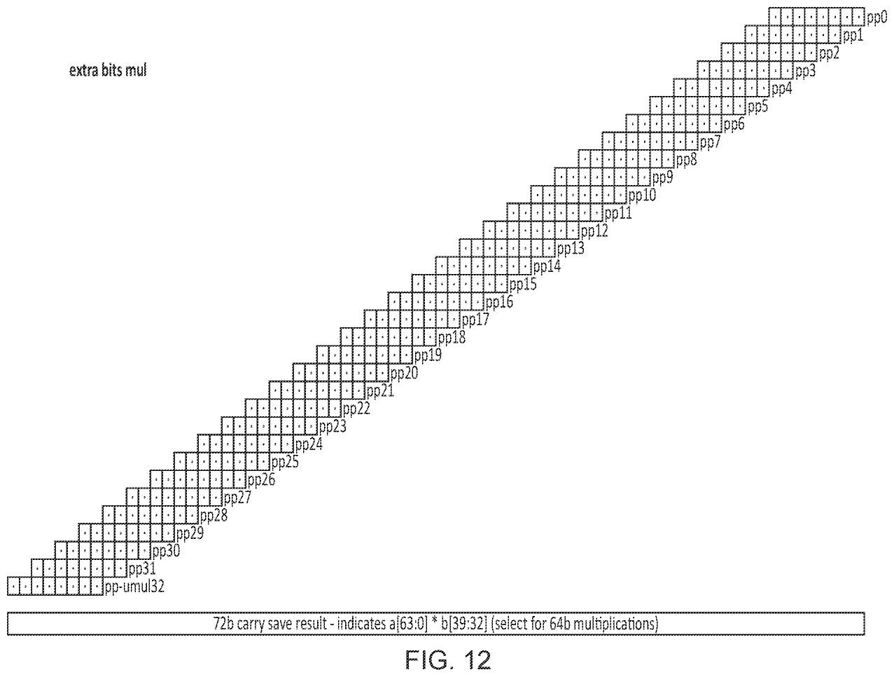

FIG. 12 illustrates the partial products for the extra bits adder array, which adds 33 partial products each comprising 8 bits, again with an offset of 2-bits per row, to produce a 72-bit carry-save result as the product representing value.

It will be appreciated that the adder array diagrams in FIGS. 9 to 12 represent the logical sequence of additions to be performed, where a given bit in the carry save result represents the sum of all bits in the corresponding column within the “adder array rhombus”. However, it is not necessary for the physical hardware circuitry to be arranged in such a rhombus, or for the bits of the corresponding partial products to be added in the same row order as shown in FIGS. 9 to 12. Any hardware circuit logic which generates an equivalent result can be used (e.g. there may be some reordering of the sequence in which the partial product bits are brought together). Also, for a given column shown in FIGS. 9 to 12 for a given adder array, addition of bits in different parts of that column could be performed in parallel before adding together the results of those sub-column additions, so it is not necessary for the partial product additions to be performed as a sequential series of additions each performed in row order. For example, for the 8-bit adder array 8 bit mul0, for the column requiring addition of bits from pp0, pp1, pp2, pp3, this could be done as two parallel additions of pp0+pp1 and pp2+pp3 before adding the results together, or as two parallel additions of pp0+pp2 and pp1+pp3 before adding the results together, or any other set of additions which gives the end result pp0+pp1+pp2+pp3. Therefore, it will be appreciated that FIGS. 9 to 12 show the logical sequence of additions used, but the physical hardware can generate equivalent results in a variety of ways.

FIG. 13 illustrates alignment for addition performed by the cooperative mode adder 58 in the 64-bit cooperative mode. The cooperative mode adder 58 adds the respective product representing values 66 generated by each adder array 56, to produce a 128-bit carry save result which represents the numeric result of the product of two 64-bit values represented by src_a [63:0] and src_b [63:0]. The bracketed terms [x:y] in FIG. 13 illustrate the alignment of each product representing value to bit lanes of the 128-bit addition—i.e. the top bit of the product representing value is aligned to bit lane x and the bottom bit of the product representing value is aligned to bit lane y. The relative offset between the product representing values in the cooperative mode addition is selected based on the relative significance of those product representing values according to the mapping shown in FIG. 6D.

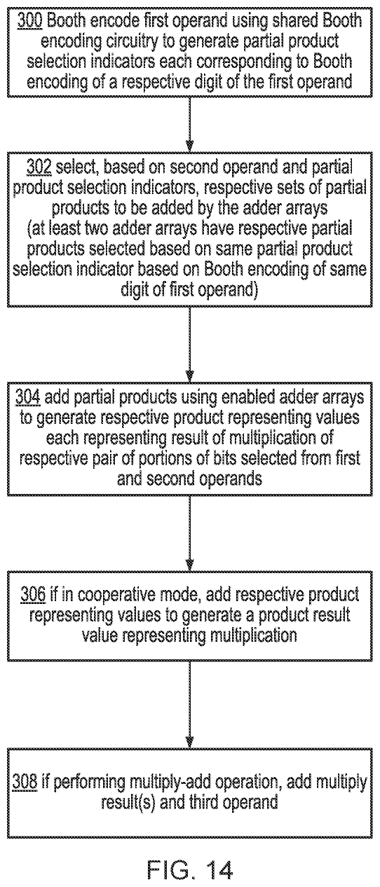

FIG. 14 illustrates a method of performing a multiplication operation on a first operand src_a and a second operand src_b using the multiplication circuitry 50 described earlier. At step 300, the first operand src_a is Booth encoded using shared Booth encoding circuitry 52, to generate partial product selection indicators 62 each corresponding to a Booth encoding of a respective Booth digit of the first operand. The shared Booth encoding circuitry 52 is shared between adder arrays 56, and the adder arrays 56 comprise separate instances of hardware circuitry where at least two subsets of the adder arrays 56 have separate enable control signals 64 for independently controlling whether each subset of adder arrays 56 is enabled or disabled. As mentioned earlier, in some implementations each adder array 56 could have its own separate enable control signal 64 to be independently enabled/disabled separate from any other adder array 56.

At step 302, the partial product selection circuitry 54 selects, based on the second operand src_b and the partial product selection indicators 62 generated by the shared Booth encoding circuitry 52, the respective sets of partial products to be added by each adder array 56. At least two of the adder arrays 56 receive partial products selected based on the same partial product selection indicator based on Booth encoding of the same Booth digit of the first operand (e.g. as shown in FIGS. 7 and 8, adder arrays 8 bit mul1, 16 bit mul0, 32 bit mul0 and the extra bits mul all receive a partial product selected based on the partial product selection indicator indicating the Booth encoding of the same Booth digit src_a [13:11] by Booth encoder benc6).

At step 304, any enabled adder arrays 56 (those adder arrays 56 for which enable control circuitry 60 has asserted the enable control signals 64 to cause the adder array to be enabled) add their respective partial products, to generate respective product representing values each representing a result of multiplication of a respective pair of portions of bits selected from the first and second operands src_a, src_b. Any adder arrays which are currently disabled (e.g. based on clamping a clock signal to a fixed value) do not add their partial products.

At step 306, if the current data element size configuration is based on a cooperative mode, the cooperating mode adder 58 adds the respective product representing values obtained by each adder array 56. In a non-cooperative mode (e.g. 8-bit, 16-bit or 32-bit configuration shown above), step 306 is not performed and instead the respective product representing values can be assembled into a result without further addition. In some implementations, the product representing values may be truncated to fit into a result of same size as the input operands src_a, src_b. Alternatively, some variants may product a result of double the size of the input operands, to preserve all bits of the product representing values.

At step 308, if performing a multiply-add operation, a further addition of the multiply result (either the result of the 64-bit multiplication produced at step 306 in the cooperative mode, or the assembled multiplication results in the non-cooperative mode configurations) and a third operand is performed, e.g. using vector adder 72 (the third operand can be a SIMD operand in the non-cooperative mode).

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The multiplication circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

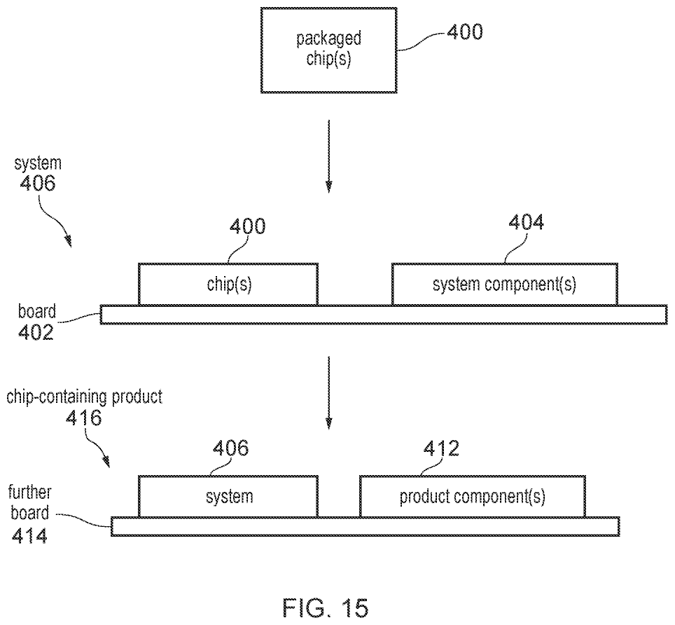

As shown in FIG. 15, one or more packaged chips 400, with the multiplication circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the multiplication circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404. For example, the board may comprise a printed circuit board. The board substrate may be made of any of a variety of materials, e.g. plastic, glass, ceramic, or a flexible substrate material such as paper, plastic or textile material. The at least one system component 404 comprises one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 410 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Some examples are set out in the following clauses:

1. Multiplication circuitry comprising:

a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;

shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and

partial product selection circuitry to select, based on the second operand and the plurality of partial product selection indicators, the partial products to be added by the plurality of adder arrays; in which:

at least two of the adder arrays are configured to operate on respective partial products selected by the partial product selection circuitry based on a same partial product selection indicator generated by the shared Booth encoding circuitry based on the Booth encoding of a same Booth digit of the first operand.

2. The multiplication circuitry according to clause 1, wherein the multiplication circuitry is configured to support at least two data element size configurations for multiplication of one or more respective pairs of data elements selected from the first operand and the second operand, each data element size configuration corresponding to a different combination of data element sizes for the data elements selected from the first operand and the second operand.
3. The multiplication circuitry according to clause 2, comprising enable control circuitry to select, based on the current data element size configuration to be used for the multiplication operation, which of the adder arrays are to be enabled and which of the adder arrays are to be disabled.
4. The multiplication circuitry according to any of clauses 2 and 3, in which, for the Booth encoding of a given Booth digit of the first operand:
for at least one of the data element size configurations for which the given Booth digit spans a data element boundary, the shared Booth encoding circuitry is configured to generate the Booth encoding of the given Booth digit based on a least significant bit of the given Booth digit being set to 0; and
for at least one other of the data element size configurations for which the given Booth digit does not span a data element boundary, the shared Booth encoding circuitry is configured to generate the Booth encoding of the given Booth digit based on said least significant bit of the given Booth digit being set to a value of a corresponding bit of the first operand.
   5. The multiplication circuitry according to any of clauses 2 to 4, wherein the plurality of adder arrays comprise at least:
a first subset of adder arrays for which each respective product representing value represents the result of multiplication of a respective pair of data elements selected from the first operand and the second operand according to a first data element size configuration; and
a second subset of adder arrays for which each respective product representing value represents the result of multiplication of a respective pair of data elements selected from the first operand and the second operand according to a second data element size configuration.
   6. The multiplication circuitry according to clause 5, in which said at least two of the adder arrays, for which the respective partial products are selected based on the same partial product selection indicator, comprise an adder array of the first subset and an adder array of the second subset.
   7. The multiplication circuitry according to clause 6, in which:

the partial product selected for the adder array of the first subset based on said same partial product selection indicator is dependent on a first subset of bits of the second operand when the multiplication is to be performed according to the first data element size configuration; and

the partial product selected for the adder array of the second subset based on said same partial product selection indicator is dependent on a second subset of bits of the second operand when the multiplication is to be performed according to the second data element size configuration.

8. The multiplication circuitry according to any of clauses 5 to 7, comprising enable control circuitry to:
set one or more enable control signals for the first subset of adder arrays to disable the first subset of adder arrays, in response to current data element size configuration information specifying that the first data element size configuration is not needed for a given multiplication operation performed on the first operand and the second operand; and
set one or more enable control signals for the second subset of adder arrays to disable the second subset of adder arrays, in response to the current data element size configuration information specifying that the second data element size configuration is not needed for the given multiplication operation.
   9. The multiplication circuitry according to any of clauses 5 to 8, in which the enable control circuitry is configured to support performing, in parallel, multiplication operations on the first and second operands using both the first data element size configuration and the second data element size configuration, by enabling both the first subset of adder arrays and the second subset of adder arrays using the enable control signals.
   10. The multiplication circuitry according to any of clauses 5 to 9, wherein the plurality of adder arrays also comprise a third subset of adder arrays for which each respective product representing value represents the result of multiplication of a respective pair of data elements selected from the first operand and the second operand according to a third data element size configuration.
   11. The multiplication circuitry according to any of clauses 1 to 10, comprising:

product adding circuitry to add, for a multiplication operation in which two or more of the adder arrays are to operate in a cooperative mode, the respective product representing values generated by two or more of the adder arrays to generate a product result value representing the multiplication of wider portions of bits of the first operand and the second operand than the portions of bits used to generate the respective product representing values for any one of said two or more of the adder arrays.

12. The multiplication circuitry according to clause 11, in which for at least one adder array, the portion of the second operand used to form the partial products for that adder array is variable depending on whether the multiplication operation is to be performed in the cooperative mode.
13. The multiplication circuitry according to any of clauses 11 and 12, in which said wider portions of bits of the first operand and the second operand comprise all magnitude-indicating bits of the first operand and the second operand.
14. The multiplication circuitry according to any of clauses 11 to 13, in which the plurality of adder arrays comprise:
a plurality of subsets of adder arrays corresponding to different data element size configurations, each subset of adder arrays comprising two or more adder arrays for generating, in a non-cooperative mode, respective product representing values representing multiplication of respective pairs of data elements selected from the first operand and the second operand according to the data element size configuration corresponding to that subset of adder arrays, where in the cooperative mode each of said plurality of subsets of adder arrays is assigned to a part of the multiplication of said wider portions; and
a further adder array to generate a further product representing value representing a result of a remaining part of the multiplication of said wider portions other than the parts assigned to the plurality of subsets of adder arrays; and the multiplication circuitry comprises enable control circuitry to disable the further adder array in the non-cooperative mode.
   15. The multiplication circuitry according to any of clauses 1 to 14, in which the plurality of adder arrays have separate enable control signals for independently controlling whether each adder array is enabled or disabled.
   16. The multiplication circuitry according to any of clauses 1 to 15, in which the separate enable control signals comprise separate clock signals.
   17. An apparatus comprising:

processing circuitry to perform data processing in response to instructions;

the processing circuitry comprising the multiplication circuitry according to any of clauses 1 to 16.

18. A system comprising:
the multiplication circuitry of any of clauses 1 to 16 or the apparatus of clause 17, implemented in at least one packaged chip;
at least one system component; and
a board,

wherein the at least one packaged chip and the at least one system component are assembled on the board.

19. A chip-containing product comprising the system of clause 18 assembled on a further board with at least one other product component.
20. A method comprising:

using shared Booth encoding circuitry shared between a plurality of adder arrays, Booth encoding a first operand to generate a plurality of sets of partial product selection indicators, each partial product selection indicator corresponding to a Booth encoding of a respective Booth digit of the first operand, wherein the plurality of adder arrays comprise separate instances of hardware circuitry, the plurality of adder arrays having at least two separate enable control signals for independently controlling whether at least two subsets of the adder arrays are enabled or disabled;

selecting, based on a second operand and the plurality of partial product selection indicators, respective sets of partial products to be added by a plurality of adder arrays; and

adding the partial products using enabled adder arrays of the plurality of adder arrays to generate respective product representing values each representing a result of multiplication of a respective pair of portions of bits selected from the first operand and the second operand,

wherein at least two of the adder arrays are configured to operate on respective partial products selected based on a same partial product selection indicator generated by the shared Booth encoding circuitry based on the Booth encoding of a same Booth digit of the first operand.

21. A computer-readable medium to store computer-readable code for fabrication of multiplication circuitry comprising:

a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;

shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and

partial product selection circuitry to select, based on the second operand and the plurality of partial product selection indicators, the partial products to be added by the plurality of adder arrays; in which:

at least two of the adder arrays are configured to operate on respective partial products selected by the partial product selection circuitry based on a same partial product selection indicator generated by the shared Booth encoding circuitry based on the Booth encoding of a same Booth digit of the first operand.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Multiplication circuitry comprising:
a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;
shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and
partial product selection circuitry to select, based on the second operand and the plurality of partial product selection indicators, the partial products to be added by the plurality of adder arrays; in which:
at least two of the adder arrays are configured to operate on respective partial products selected by the partial product selection circuitry based on a same partial product selection indicator generated by the shared Booth encoding circuitry based on the Booth encoding of a same Booth digit of the first operand.

2. The multiplication circuitry according to claim 1, wherein the multiplication circuitry is configured to support at least two data element size configurations for multiplication of one or more respective pairs of data elements selected from the first operand and the second operand, each data element size configuration corresponding to a different combination of data element sizes for the data elements selected from the first operand and the second operand.

3. The multiplication circuitry according to claim 2, comprising enable control circuitry to select, based on the current data element size configuration to be used for the multiplication operation, which of the adder arrays are to be enabled and which of the adder arrays are to be disabled.

4. The multiplication circuitry according to claim 2, in which, for the Booth encoding of a given Booth digit of the first operand:
for at least one of the data element size configurations for which the given Booth digit spans a data element boundary, the shared Booth encoding circuitry is configured to generate the Booth encoding of the given Booth digit based on a least significant bit of the given Booth digit being set to 0; and
for at least one other of the data element size configurations for which the given Booth digit does not span a data element boundary, the shared Booth encoding circuitry is configured to generate the Booth encoding of the given Booth digit based on said least significant bit of the given Booth digit being set to a value of a corresponding bit of the first operand.

5. The multiplication circuitry according to claim 2, wherein the plurality of adder arrays comprise at least:
a first subset of adder arrays for which each respective product representing value represents the result of multiplication of a respective pair of data elements selected from the first operand and the second operand according to a first data element size configuration; and
a second subset of adder arrays for which each respective product representing value represents the result of multiplication of a respective pair of data elements selected from the first operand and the second operand according to a second data element size configuration.

6. The multiplication circuitry according to claim 5, in which said at least two of the adder arrays, for which the respective partial products are selected based on the same partial product selection indicator, comprise an adder array of the first subset and an adder array of the second subset.

7. The multiplication circuitry according to claim 6, in which:
the partial product selected for the adder array of the first subset based on said same partial product selection indicator is dependent on a first subset of bits of the second operand when the multiplication is to be performed according to the first data element size configuration; and
the partial product selected for the adder array of the second subset based on said same partial product selection indicator is dependent on a second subset of bits of the second operand when the multiplication is to be performed according to the second data element size configuration.

8. The multiplication circuitry according to claim 5, comprising enable control circuitry to:
set one or more enable control signals for the first subset of adder arrays to disable the first subset of adder arrays, in response to current data element size configuration information specifying that the first data element size configuration is not needed for a given multiplication operation performed on the first operand and the second operand; and
set one or more enable control signals for the second subset of adder arrays to disable the second subset of adder arrays, in response to the current data element size configuration information specifying that the second data element size configuration is not needed for the given multiplication operation.

9. The multiplication circuitry according to claim 5, in which the enable control circuitry is configured to support performing, in parallel, multiplication operations on the first and second operands using both the first data element size configuration and the second data element size configuration, by enabling both the first subset of adder arrays and the second subset of adder arrays using the enable control signals.

10. The multiplication circuitry according to claim 5, wherein the plurality of adder arrays also comprise a third subset of adder arrays for which each respective product representing value represents the result of multiplication of a respective pair of data elements selected from the first operand and the second operand according to a third data element size configuration.

11. The multiplication circuitry according to claim 1, comprising:
product adding circuitry to add, for a multiplication operation in which two or more of the adder arrays are to operate in a cooperative mode, the respective product representing values generated by two or more of the adder arrays to generate a product result value representing the multiplication of wider portions of bits of the first operand and the second operand than the portions of bits used to generate the respective product representing values for any one of said two or more of the adder arrays.

12. The multiplication circuitry according to claim 11, in which for at least one adder array, the portion of the second operand used to form the partial products for that adder array is variable depending on whether the multiplication operation is to be performed in the cooperative mode.

13. The multiplication circuitry according to claim 11, in which the plurality of adder arrays comprise:
a plurality of subsets of adder arrays corresponding to different data element size configurations, each subset of adder arrays comprising two or more adder arrays for generating, in a non-cooperative mode, respective product representing values representing multiplication of respective pairs of data elements selected from the first operand and the second operand according to the data element size configuration corresponding to that subset of adder arrays, where in the cooperative mode each of said plurality of subsets of adder arrays is assigned to a part of the multiplication of said wider portions; and
a further adder array to generate a further product representing value representing a result of a remaining part of the multiplication of said wider portions other than the parts assigned to the plurality of subsets of adder arrays; and
the multiplication circuitry comprises enable control circuitry to disable the further adder array in the non-cooperative mode.

14. The multiplication circuitry according to claim 1, in which the plurality of adder arrays have separate enable control signals for independently controlling whether each adder array is enabled or disabled.

15. The multiplication circuitry according to claim 1, in which the separate enable control signals comprise separate clock signals.

16. An apparatus comprising:
processing circuitry to perform data processing in response to instructions;
the processing circuitry comprising the multiplication circuitry according to claim 1.

17. A system comprising:
the multiplication circuitry of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A method comprising:
using shared Booth encoding circuitry shared between a plurality of adder arrays, Booth encoding a first operand to generate a plurality of sets of partial product selection indicators, each partial product selection indicator corresponding to a Booth encoding of a respective Booth digit of the first operand, wherein the plurality of adder arrays comprise separate instances of hardware circuitry, the plurality of adder arrays having at least two separate enable control signals for independently controlling whether at least two subsets of the adder arrays are enabled or disabled;
selecting, based on a second operand and the plurality of partial product selection indicators, respective sets of partial products to be added by a plurality of adder arrays; and
adding the partial products using enabled adder arrays of the plurality of adder arrays to generate respective product representing values each representing a result of multiplication of a respective pair of portions of bits selected from the first operand and the second operand,
wherein at least two of the adder arrays are configured to operate on respective partial products selected based on a same partial product selection indicator generated by the shared Booth encoding circuitry based on the Booth encoding of a same Booth digit of the first operand.

20. A non-transitory computer-readable medium to store computer-readable code for fabrication of multiplication circuitry comprising:
a plurality of adder arrays each to add a respective set of partial products to generate a respective product representing value representing a result of multiplication of a respective pair of portions of bits selected from a first operand and a second operand, the plurality of adder arrays comprising separate instances of hardware circuitry, the plurality of adder arrays having at least two separate enable control signals for independently controlling whether at least two subsets of the adder arrays are enabled or disabled;
shared Booth encoding circuitry, shared between the plurality of adder arrays, to Booth encode the first operand to generate a plurality of partial product selection indicators, each partial product selection indicator corresponding to a Booth encoding of a respective Booth digit of the first operand; and
partial product selection circuitry to select, based on the second operand and the plurality of partial product selection indicators, the partial products to be added by the plurality of adder arrays; in which:
at least two of the adder arrays are configured to operate on respective partial products selected by the partial product selection circuitry based on a same partial product selection indicator generated by the shared Booth encoding circuitry based on the Booth encoding of a same Booth digit of the first operand.
